(19) United States
(12) Patent Application Publication
(10) Pub. No.: US 2004/0079152 A1
(43) Pub. Date: Apr. 29, 2004

(54) Remote fluid level detection system

(75) Inventors: Chad M. Sorenson, Madison, WI (US); Scott Woods, Delavan, WI (US); Dave Franchino, Madison, WI (US)

Correspondence Address: MICHAEL BEST & FRIEDRICH, LLP, ONE SOUTH PINCKNEY STREET, P O BOX 1806, MADISON, WI, 53701

(73) Assignee: Fluent Systems, LLC, Madison, WI

(21) Appl. No.: 10/685,156

(22) Filed: Oct. 14, 2003

Related U.S. Application Data
(63) Continuation-in-part of application No. 10/061,506, filed on Feb. 1, 2002.
(60) Provisional application No. 60/265,317, filed on Feb. 1, 2001.

(51) Int. Cl. G01F 23/38; G01F 11/10; G01F 11/28; G01F 15/06

(52) U.S. Cl. 73/313; 702/55; 702/45; 700/283; 73/292; 340/870.05

(57) ABSTRACT

A remote two-module electronic fluid monitoring system. A tank module sits atop a field tank and monitors internal fluid level. Fluid level detection is achieved by tracking the position of an embedded permanent magnet associated with a given internal fluid level within an existing float gauge mechanism. An integrated circuit capable of precisely detecting the orientation of magnetic fields senses the angular position of an existing magnet and outputs an angular field reading to an interfaced microcontroller which then translates angular reading to fluid level. The tank module contains a radio frequency transmitter which then sends fluid level information to a display module. The display module receives the signal from the tank module and reports to the user the present fluid level remaining in the tank via a liquid crystal display.

### CROSS-REFERENCE TO RELATED APPLICATIONS

This application is a continuation-in-part application of U.S. patent application Ser. No. 10/061,506 filed Feb. 1, 2002, which claims the benefit of the filing date of U.S. Provisional Application No. 60/265,317. Both applications are herein incorporated by reference.

### BACKGROUND OF INVENTION

This invention relates to a remote fluid level detection system. The system uses magnetic detection to determine the fluid level in a confined vessel. Suitably, the invention is utilized with anhydrous ammonia field tanks, but can be used with any liquid contained in a tank, such as propane.

Anhydrous ammonia (NH₃) is a substance used in agriculture as a fertilizer because of its high nitrogen content. Typically, anhydrous ammonia is applied to fields in the fall after the crop has been harvested to replenish the nutrients for the next season. The application of anhydrous ammonia involves the use of a field tractor, a field implement that is pulled behind the tractor, and a large anhydrous ammonia tank that is pulled behind the implement. This creates a relatively long, train-like configuration of machinery.

Anhydrous ammonia is a multi-phase chemical that, when stored under pressure in the field tank, is in the liquid phase. Upon application, the fertilizer is injected into the topsoil, and it undergoes a phase transformation while percolating through the soil in a gaseous state. Since anhydrous ammonia is a hazardous material, and needs to be stored under pressure, the field tanks are made of heavy gauge steel; much like propane tanks for remote residential use. As a result, the fluid level inside the tank is not visible and a special measurement device is needed to indicate the fluid level remaining in the tank.

Many existing fluid level sensing systems make use of a magnetic float gauge assembly. Such an assembly comprises an aluminum float-arm that pivots about the center of the tank (see U.S. Pat. No. 2,795,955, incorporated herein by reference). As fluid levels change within the tank, the buoyancy of the anhydrous ammonia affects the position of the internal float. The arm is mechanically coupled via bevel gears to a vertical shaft that runs to the top of the holding tank. Fluctuations in the position of the internal float translate to a small angular rotation of the vertical shaft. To keep the tank completely sealed, a permanent magnet is attached to the top of the vertical shaft. On the outside of the tank, a simple local compass, with fluid level markings, then tracks the position of the internal magnet. In this way, the fluid level of the anhydrous ammonia tank is made visible to the farmer without creating any opportunity for leaks since there are no through-holes or seals needed for the tank gauge to function.

This type of gauge system, however, has many shortcomings. When the farmer is applying the anhydrous ammonia, the fluid level inside the tank is not known because the size and orientation of the gauge face render it completely unreadable from the cab of the tractor. This situation makes it necessary for the farmer to periodically stop application of anhydrous ammonia, get out of the tractor, and walk forty feet back to the field tank to read the small dial on the top of the tank. A standard 1450 gallon anhydrous ammonia field tank is sufficient for only 40 acres of farmland, so the tedious task of determining the fluid level as the tank reaches empty is a recurring annoyance that results in degraded time efficiency.

Another shortcoming of the prior system is that the total amount of dispensed ammonia is not accurately known until the tank has been emptied. When the tank has been emptied, the farmer can finally approximate the total acreage covered by one full tank, and thus the application rate per acre.

The need exists, therefore, for a means by which fluid level may be known to the farmer on a continuous basis from within the tractor cab during the application process.

### SUMMARY OF INVENTION

The present invention relates to a remote fluid level detection system which provides information to the user, in a wireless fashion, on the fluid level of a towed tank. The present invention is suitably designed for use with a tank containing anhydrous ammonia, but can be practiced with any tank containing fluid and a magnetic float gauge assembly.

Fluid level information is available on a continuous basis as fluid application is occurring. This eliminates the current need to stop application to physically read the existing gauge mechanism on the field tank.

In one embodiment the invention is composed of two electronic modules, a tank module and a display module, that communicate with each other by wireless means, namely a radio frequency transmission. In another embodiment the invention is utilized with a flow control system, whereby the tank module communicates fluid information to a control console of the flow control system.

The tank module is affixed atop the existing mechanical gauge mechanism on a towed field tank, and utilizes a magnetic detection scheme to sense the orientation of a local magnetic field produced by the embedded magnet of the float gauge assembly. The position of the embedded magnet corresponds with the fluid level within the tank.

In one embodiment the tank module comprises a magnetic sensor, a radio transmitter, a microcontroller, a housing and an attachment band.

In another embodiment the tank module comprises a lower magnetic sensor, an upper magnetic sensor, a microcontroller, a radio transmitter, an electronic thermometer, a housing and an attachment band.

The tank module can be quickly and easily installed to existing fluid measurement hardware on a tank by the use of the attachment band. The attachment band comprises an adjusting bolt, a clamp lever and a collar section having a bottom channel, a main opening and an upper channel. The attachment band captures the head of the existing gauge firmly and without the use of any tools. This allows for the tank module to easily be moved from tank to tank with very little effort and time. This also allows the present invention to be utilized without requiring any modifications or removal of any existing hardware and therefore is a completely safe and easy to use fluid level detecting system that does not adversely affect the performance and safety of the original system. The means by which magnetic detection is achieved in the present invention is sufficiently sensitive to eliminate the need for removal or modification of the existing gauge face on an anhydrous ammonia tank.

The tank module is designed to accommodate a number of possible mechanical gauge configurations found on a tank, such that various bolt patterns and gauge head geometries will interface equally well with the tank module. The geometric constraints of the tank module limit the orientation by which the invention may be installed to two distinct orientations: an orientation aligned with the magnetic sensing element, and an orientation 180 degrees offset from the magnetic sensing element. In the event the tank module is installed on the existing gauge mechanism 180 degrees offset from the orientation of the internal magnetic sensing element, the control firmware identifies this misalignment and resets the internal origin to compensate for this misalignment, such that the invention will operate equally well in either one of the two mounting orientation possibilities.

Prior fluid level detection gauges utilizing magnetic fields often do so as a means to merely detect low fluid levels or to detect fluid levels at one of several discrete fluid levels. The present invention utilizes a magnetic detection scheme that permits much higher resolution and therefore a much more precise indication of the internal fluid level over a continuum between “full” and “empty.” The capability of more precisely monitoring fluid levels using this magnetic detection scheme may then be used in conjunction with other inputs to output secondary information that would not have previously been possible.

Within the tank module, a microcontroller based electronic circuit detects the orientation of the magnetic field being generated by the permanent magnet inside the existing gauge mechanism. This magnetic orientation detection is accomplished by utilizing a magnetic sensor, or suitably a pair of magnetic sensors (an upper and lower sensor). Suitably the magnetic sensor is a magnetoresistive sensor. The magnetic sensor is capable of interfacing with the microcontroller within the tank module and reports the orientation of the magnetic field to one degree of precision or better. This allows the microcontroller to locate precisely the position of the embedded tank magnet, and consequently the corresponding internal fluid level. Data stored in an internal look-up table within the tank module microcontroller is referenced to translate the magnetic -field orientation reading to a usable fluid level value that corresponds with a percentage of fluid remaining in the tank.

The tank module is equipped with a radio frequency (RF) transmitter that encodes the resulting fluid level data, and transmits it in a wireless fashion to a display module suitably mounted inside the tractor cab. The display module receives the signal from the tank module, decodes the information and utilizes this information for a number of purposes.

In one embodiment, the display module comprises a radio receiver, a microcontroller, a display and a housing.

Information on the current fluid level can be directly conveyed to the user within the tractor cab via a visible liquid crystal display in the display module. Additionally, a “tank low” audible alert can be included in the system to notify the user when the fluid level has dropped beneath a certain threshold.

The display module can include a means by which it can interface with the tractor's electronic groundspeed indicator, thereby providing information to the display module on the tractor's rate of travel through the field. The display module also permits the user to input information on the size of the anhydrous ammonia field tank and the width of the field implement, the acres covered in the application process, and other useful information.

Information from the tank module on the current fluid level can be combined with information on the tractor's groundspeed, information on the anhydrous ammonia tank size, and information on the width of the field implement, to provide useful secondary information, such as the average application rate per acre.

The present invention can display information on the time remaining until the tank is empty, number of acres covered per tank and warnings if fluid levels drop faster than a set threshold, which would indicate a burst hose or other catastrophic event. The present invention permits this calculation to occur much earlier in the application process, and thus allows the user to compensate for any error between the desired application rate and actual application rate. The invention, therefore, can lead to significant material savings if these errors in over-application are caught earlier rather than later. Furthermore, the invention can catch under-application errors, which can lead to even greater adverse economic consequences than over-application due to the loss of crop yield.

The present invention also provides various methods of use of the fluid detection system.

In one embodiment the invention provides a method of detecting a fluid level in a tank using the fluid detection system. The method comprises attaching the tank module to a tank having a magnetic float gage assembly which includes a magnet. The magnetic field intensity of the magnet of the magnetic float gage assembly is then detected by the use of the lower magnetic sensor of the tank module. If the intensity is above a set threshold, the microcontroller of the tank module uses the upper magnetic sensor to determine the angular position of the magnetic field of the magnet. If the intensity is below the set threshold, the microcontroller of the tank module uses the lower magnetic sensor to determine the angular position of the magnetic field of the magnet. The fluid level in the tank is then determined by the use of the tank module microcontroller, based on the angular position of the magnetic field detected.

In another embodiment the invention provides a method of detecting and displaying a fluid level in a tank using the fluid detection system of the present invention. The fluid level in the tank is determined as outlined above by the tank module and transmitted to the display module by the use of a radio frequency transmission. The fluid level in the tank is then displayed on the display of the display module.

In another embodiment the invention provides a method of calculating the application rate per acre of fluid dispensed from a tank using the fluid level detection system. The method comprises detecting the fluid level in the tank as outlined above by the tank module. The fluid level is suitably determined at a starting point and an endpoint. The fluid levels of the tank are transmitted to the display module by the use of a radio frequency transmission. The number of acres covered between the starting and ending point are then entered into the display module, suitably by the use of input buttons on the display module. The rate per acre is then calculated, suitably by the display module microcontroller.

The present invention also provides a method of calculating the mass of fluid dispensed from a tank using the fluid detection system. The method comprises detecting the fluid level in the tank as outlined above by the tank module. The fluid level is suitably determined at a starting point and an endpoint. The fluid levels of the tank are transmitted to the display module by the use of a radio frequency transmission. The ambient temperature of the tank is determined by the use of an electronic thermometer which is included in the tank module. In one embodiment the thermometer is integral to the tank module microcontroller. The temperature of the tank is transmitted to the display module. The volume of liquid dispensed is calculated by the difference in volume between the fluid level at the start point and the fluid level at the end point, suitably by the use of the display module microcontroller. The density of liquid anhydrous ammonia at the ambient temperature is then calculated, suitably by the use of the microcontroller of the display module. The mass of fluid dispensed from the tank is then calculated, suitably by the use of the microcontroller of the display module.

The present invention also includes a method of detecting the fluid level in a tank which compensates for sloshing using the fluid detection system. The method comprises detecting the fluid level in the tank as outlined above by the tank module. The fluid level is suitably determined at a first time and a second time. An average fluid level using the fluid level at the first time and the fluid level at the second time is calculated, suitably by the tank module microcontroller.

The present invention also provides for a fluid level detection system which can sense the fluid level in multiple tanks and display the fluid level in each tank on a single display. This fluid control system comprises a first tank module, wherein the first tank module comprises a lower magnetic sensor, an upper magnetic sensor, a microcontroller, a radio transmitter, and a housing. It also includes a second tank module comprising a lower magnetic sensor, an upper magnetic sensor, a microcontroller, a radio transmitter, and a housing. It further includes a display module comprising a radio receiver, a microcontroller, a display and a housing.

In another embodiment the present invention provides a method of using the two-tank fluid detection system to detect and display the fluid level of two tanks. The first and second tank modules are attached to first and second tanks, respectively. Each tank has a magnetic float gage assembly which includes a magnet. By the use of the lower magnetic sensor of the first tank module, the magnetic field intensity of the magnet of the first tank is detected. If the intensity is above a set threshold, the microcontroller of the first tank module uses the upper magnetic sensor of the first tank module to determine the angular position of the magnetic field of the magnet of the first tank. If the intensity is below the set threshold, the microcontroller of the first tank module uses the lower magnetic sensor of the first tank module to determine the angular position of the magnetic field of the magnet of the first tank. The fluid level in the first tank is determined by the use of the first tank module microcontroller, based on the angular position of the magnetic field detected. This fluid level is then transmitted to the display module by the use of a radio frequency transmission having a first signature indicator. By the use of the lower magnetic sensor of the second tank module, the magnetic field intensity of the magnet of the second tank is detected. If the intensity is above a set threshold the microcontroller of the second tank module uses the upper magnetic sensor of the second tank module to determine the angular position of a magnetic field of the magnet of the second tank. If the intensity is below the set threshold, the microcontroller of the second tank module uses the lower magnetic sensor of the second tank module to determine the angular position of the magnetic field of the magnet of the second tank. The fluid level in the second tank is determined by the use of the second tank module microcontroller, based on the angular position of the magnetic field detected. The fluid level is transmitted to the display module by the use of a radio frequency transmission having a second signature indicator. The fluid level in the first and second tank is then displayed on the display of the display module.

In another embodiment the present invention provides a method of determining the application rate per acre for at least two tanks using the two-tank fluid detection system. The fluid level in the first tank and second tank is determined as indicated above at a starting point and ending point. The fluid levels of the first and second tank at the starting and ending points are transmitted to the display module. The number of acres covered between the starting and ending point are then entered in the display module, suitably by the use of input buttons on the display module. The application rate per acre is then calculated, suitably by the microcontroller of the display module.

The invention also includes a method for calculating the mass of fluid dispensed from at least two tanks using the fluid detection system. The method comprises detecting the fluid level in the first and second tank as outlined above at a starting point and an end point. The fluid levels of the first and second tank at the starting and ending points are transmitted to the display module. The ambient temperature of the tank is determined by the use of an electronic thermometer which is included in the tank module. The temperature of the tank is transmitted to the display module. The volume of liquid dispensed is calculated by the difference in volume between the fluid level at the start point and the fluid level at the end point of the first and second tanks, suitably by the use of the display module microcontroller. The density of liquid anhydrous ammonia at the ambient temperature is then calculated, suitably by the use of the microcontroller of the display module. The mass of fluid dispensed from the tank is then calculated, suitably by the use of the microcontroller of the display module.

The present invention also utilizes the wireless fluid detection system in concert with a flow control system. Such a flow control system comprises a tank module including a magnetic sensor, a microcontroller, a radio transmitter, and a housing. The system also comprises a control console comprising a radio receiver, a microcontroller and a display. The flow control system also includes a flow control turbine and a shutoff solenoid.

The invention also encompasses methods of using the flow control system. In one embodiment the invention encompasses a method of detecting and displaying the fluid level in a tank using the flow control system. The method comprises attaching the tank module to the tank, the tank having a magnetic float gage assembly which includes a magnet. The magnetic sensor of the tank module is used to determine the angular position of the magnetic field of the magnet. The fluid level of the tank is then determined by the tank module microcontroller based on the angular position of the magnetic field detected. The fluid level is then transmitted to the control console by use of a radio frequency transmission. The fluid level is displayed on the display of the control console.

The present invention also includes a method for determining the application rate of fluid using a flow control system. The method comprises detecting the fluid level in a tank as described above at a first and second time period. The tank module then determines the difference in fluid level between the first time and second time, suitably by use of the tank module microcontroller. The tank module microcontroller then determines the application rate of the fluid.

Another embodiment of the present invention is a method alerting a user to an error in the application rate of a flow control system. The method comprises determining an actual fluid application rate using the tank module as described above. A programmed application rate of the flow control system is stored in the control console. The difference between the programmed application rate and the actual application rate is then determined, suitably by the microcontroller of the control console. The user is then alerted, suitably by an audible noise or on the visual display of the control console, of the difference between the programmed application rate and the actual application rate.

The invention also encompasses a method of automatically shutting off the application of fluid from a tank using the flow control system. The method comprises detecting the fluid level in the tank according to the method delineated above. A shut off fluid level is entered into the microcontroller of the control console. If the fluid level drops below the shutoff level, the control console microcontroller signals the shutoff solenoid to shut off the flow to the flow control turbine.

Other features and advantages of the invention will become apparent to those skilled in the art upon review of the following detailed description and drawings.

### BRIEF DESCRIPTION OF THE DRAWINGS

FIG. 1 is a side view of a typical agricultural set-up for the application of the fluid level detection system of the present invention for use with an anhydrous ammonia tank.

FIG. 2 is a cut-away side view of a tank showing detail of the existing internal float gauge mechanism.

FIG. 3. is a partial side view of one embodiment of the tank module of the present invention mounted on a tank.

FIG. 4 is a partial side view of the two sensor tank module of the present invention mounted on float gage mechanism.

FIG. 5 is a top perspective view of one embodiment of the tank module of the present invention.

FIG. 6 is a bottom perspective view of one embodiment of the tank module of the present invention.

FIG. 7 is an exploded view of a portion of one embodiment of the tank module of the present invention.

FIG. 8 is an exploded view of a portion of one embodiment of the two sensor tank module of the present invention.

FIG. 9 is an exploded view of a portion of one embodiment of the tank module of the present invention.

FIG. 10 is a top view of an attachment band of the present invention.

FIG. 11 is a front perspective view of the display module of the present invention.

FIG. 12 is a back perspective view of the display module of the present invention.

FIG. 13 is an exploded view of a portion of the display module of the present invention.

FIG. 14 is an exploded view of a portion of the display module of the present invention.

FIG. 15 is a top cutaway view of the tank module mounted on a gauge in a correct orientation, and showing the expected initial angular position of the embedded magnet of the existing gauge mechanism.

FIG. 16 is a top cutaway view of the tank module mounted on a gauge in an incorrect orientation, and showing the expected initial magnetic reading of the tank module.

FIG. 17 is a top cutaway view of the tank module mounted on a gauge in an incorrect orientation, and showing the corrected angular reading of the tank module.

FIG. 18 is a diagram of the configuration of the flow control system of the present invention.

FIG. 19 is a circuit block diagram showing the connections of the circuit of the tank module.

FIG. 20 is a dataflow diagram showing the process carried out by the tank module.

FIG. 21 is a circuit block diagram showing the connections of the circuit of the display module.

FIG. 22 is a dataflow diagram showing a process that can be carried out by the display module.

FIG. 23 is a side, cutaway view of a tank at an incline.

FIG. 24 is a side view of a flow control set up.

FIG. 25 is a cutaway perspective view of a control console of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use of “including”, “having” and “comprising” and variations thereof herein is meant to encompass the items listed thereafter and equivalents thereof as well as additional items and equivalents thereof.

### DETAILED DESCRIPTION

This invention relates to a remote fluid level detection system using magnetic detection to determine the fluid level from a confined tank. The present invention is suitably designed for use with a pressurized tank containing anhydrous ammonia, but can be practiced with any tank containing fluid and a magnetic float gauge assembly.

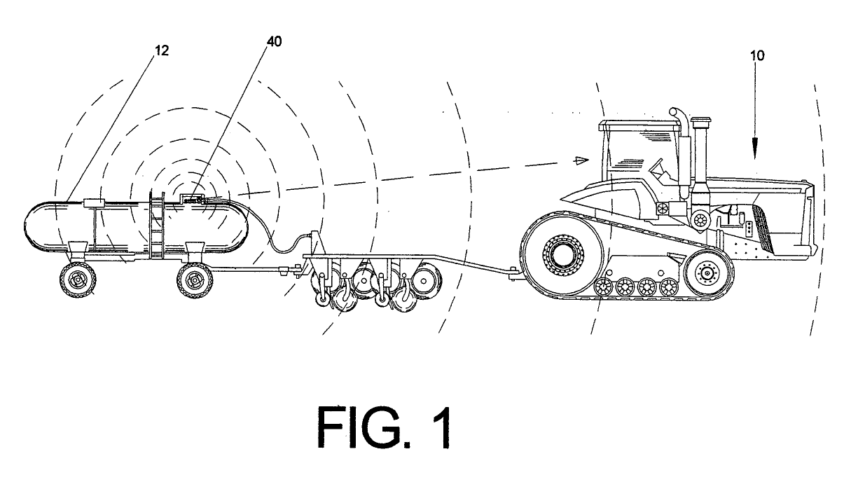

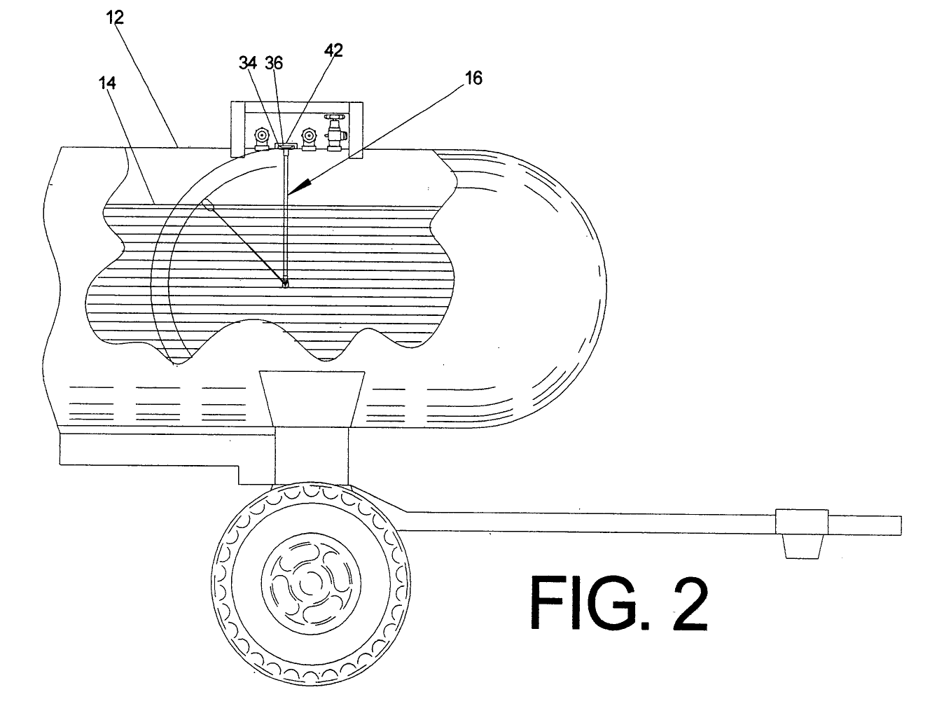

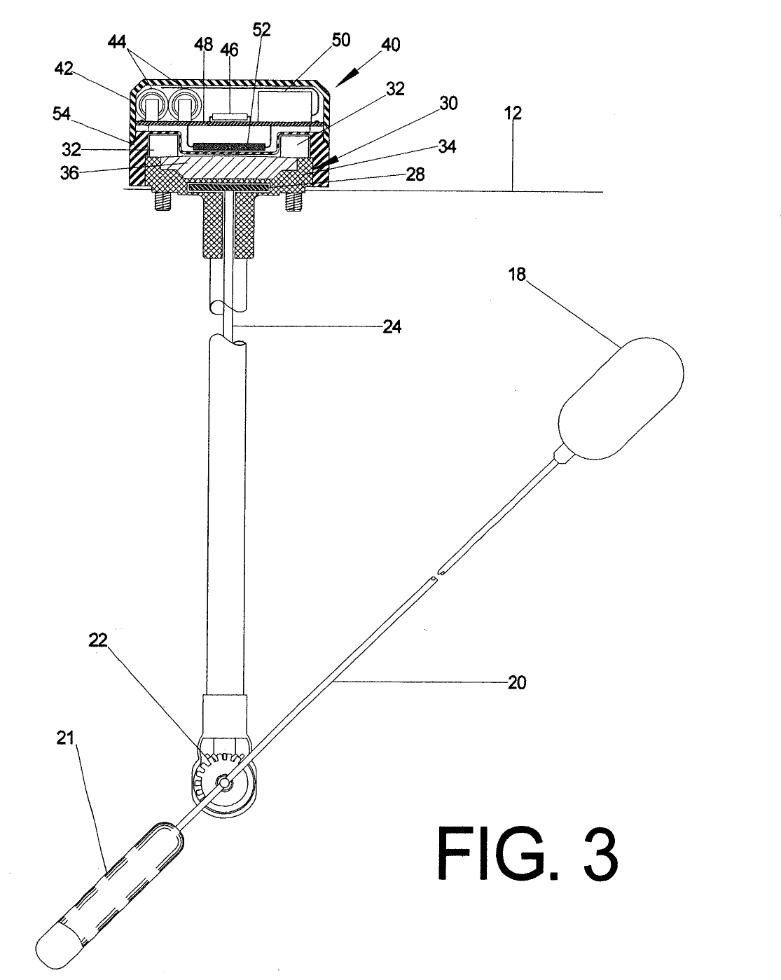

A typical agriculture set-up in which the present invention is utilized is depicted in FIGS. 1-2. A tractor 10 tows a pressurized tank 12 containing a fluid 14 to be applied to a field. The pressurized tank 12 contains a float gauge assembly 16. The float gauge assembly 16 is depicted in FIGS. 2 and 3. The float gauge assembly 16 comprises a float 18, a float arm 20, a counterweight 21, bevel gears 22, a vertical shaft 24, a magnet 28, and a gauge 30. The float 18 is attached to a float arm 20 that pivots about the center of the tank. The arm 20 is mechanically coupled via bevel gears 22 to the vertical shaft 24 that runs to the top of the tank 12. As the fluid 14 level changes within the tank 12 the buoyancy of the fluid 14 affects the position of the float 18. Fluctuations in the position of the float 18 translate to a small angular rotation of the vertical shaft 24. The magnet 28 is attached to the top of the vertical shaft 24. On the outside of the tank 12, the gauge 30 is mounted by mounting bolts 32 which connect the gauge housing 34 to the tank 12. The face of the gauge 36 comprises a simple compass which tracks the position of the magnet 28.

### Single Magnetic Sensor Tank Module

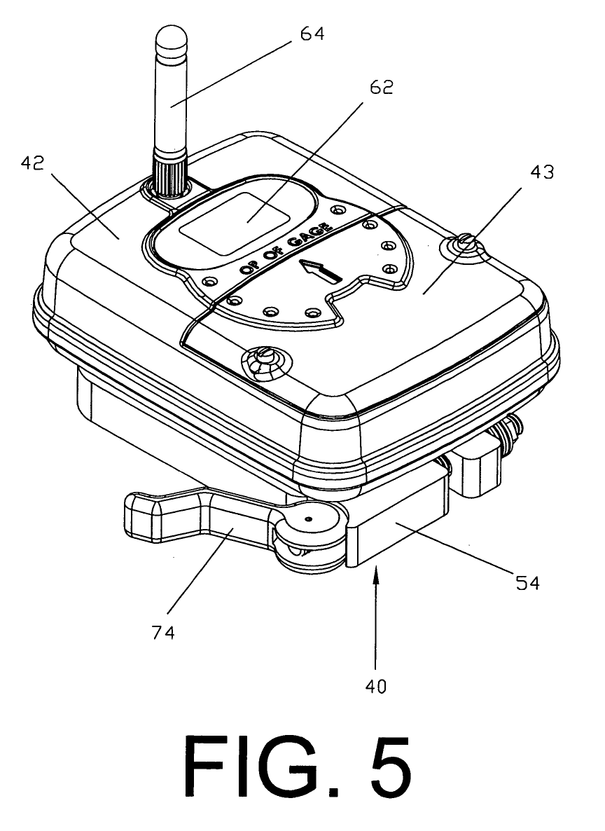

One embodiment of the tank module 40 of the present invention is depicted in FIGS. 3 and 5-6. The tank module comprises a housing 42, a battery cover 43, battery units 44, a microcontroller 46, a circuit board 48, an RF transmitter 50, a magnetic sensor 52, an attachment band 54, a momentary switch, an electric inclinometer, a liquid crystal display 62, a clock oscillator, and a voltage regulator.

The housing 42 of the tank module 40 is dimensioned to fit over the pre-existing gauge 30 of a tank 12, and is secured to the gauge 30 by way of the attachment band 54. The housing 42 is suitably comprised of a durable metal such as aluminum or can be crafted from plastic.

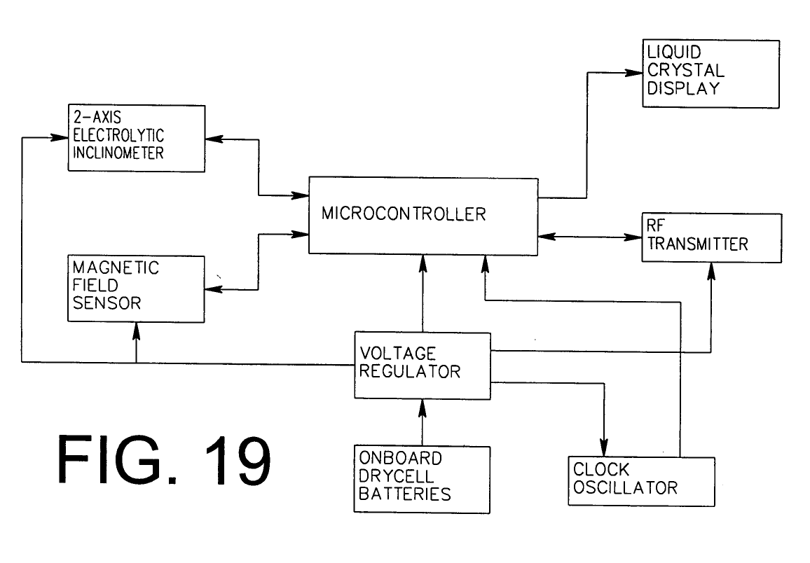

One embodiment of the physical and circuit connections of the tank module 40 are detailed in FIGS. 3-6 and 19. The arrows in FIG. 19 indicate the input/output relationship between the circuit components of the tank module. The onboard battery 44, suitably a 9V or a number of AA batteries, is regulated to +3V by the voltage regulator, which provides power to all components on common +3V and ground connections. A 16-bit microcontroller 46 houses all system software and serves as the nerve center for the system. Suitable microcontrollers are readily commercially available. Suitable microcontrollers include Texas Instruments TI MSP430 or MSP430F435. The clock oscillator outputs a 4 MHz square wave to the microcontroller 46 for timing reference. The inclinometer, magnetic sensor 52, liquid crystal display 62 and RF transmitter 50 incorporate an interface with the microcontroller. Suitable magnetic sensors are readily commercially available.

Suitably the magnetic sensor is a magnetoresistive sensor, such as the Honeywell HMC1052 high performance 2-axis magnetoresistive sensor manufactured by Honeywell International Inc. Suitably, the magnetoresistive sensor is configured as a 4-element Wheatstone bridge to convert magnetic fields to differential output voltages. With the power supply applied to the bridge, the sensor converts any incident magnetic field in the sensitive direction to a balanced voltage output. In the presence of a magnetic field, a change in the bridge resistive elements causes a corresponding change in the voltage across the bridge outputs. The magnetic sensor consists of two separate magnetic sensing elements, oriented 90 degrees apart such that the output signals equivalent to a sine and a cosine. The signals are bipolar from nominal and thus cover a full 360-degree spectrum. The sensor is mounted on the center of rotation of the embedded magnet in the float gauge head so that it can receive a field that varies in direction, but little in magnitude. Once the sine and cosine of the magnetic field orientation are established, a corresponding angular measurement relative to a preset origin can be found by taking the arctangent of the sine divided by the cosine measurement. The angular measurement is stored as a variable within the microcontroller's memory.

Suitable electronic inclinometers are also readily available, suitable inclinometers include the SPECTRON SP5003-A-000 inclinometer from Spectron Systems Technology.

### Two Sensor Tank Module

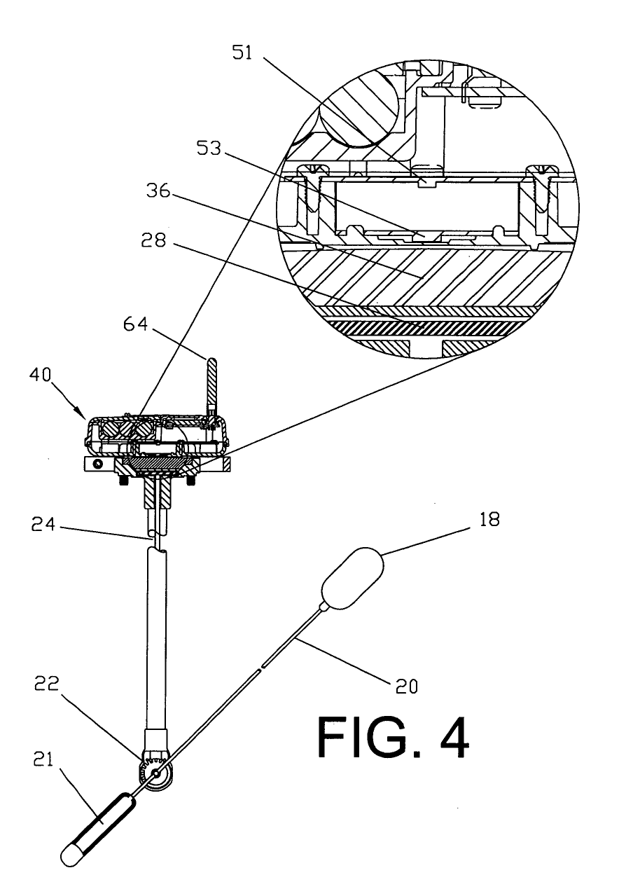

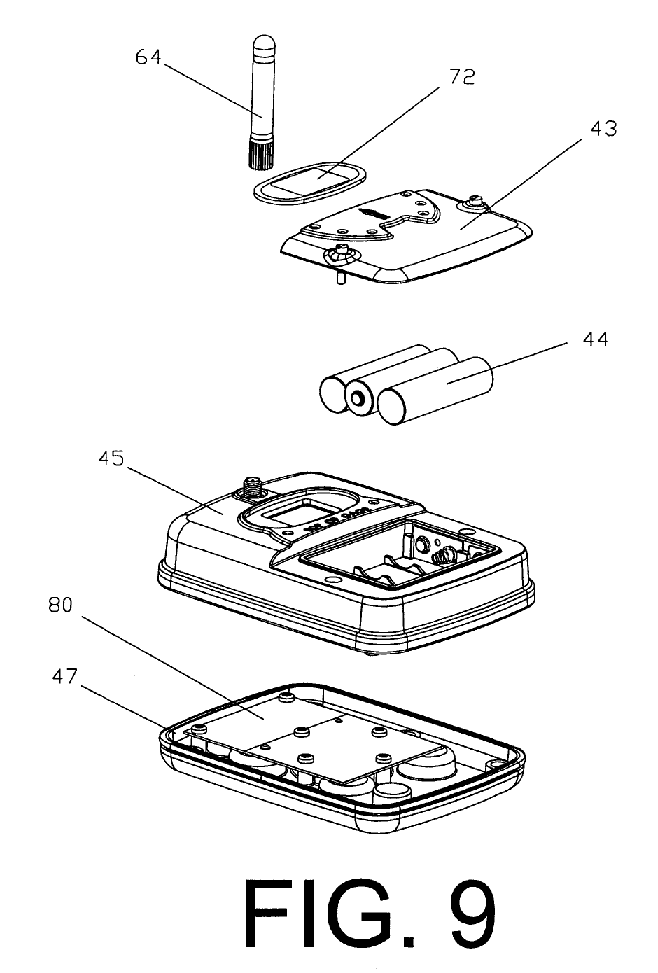

In another embodiment of the present invention, the invention provides a fluid detection system with a tank module containing two magnetic sensors. This embodiment of the invention is shown in FIGS. 4-9. The tank module 40 in part comprises a housing 42 having an upper half 45 and lower half 47, and an O-ring 85. The lower half 47 of the housing 42 has gauge bolt clearance cavities 70 which allow the tank module 40 to be easily fit on a gauge 30. An attachment band 54 is also part of the tank module. The tank module further comprises a battery cover 43, batteries 44, and battery contacts 41. The tank module further includes a display 62, a display cover 72 and an antenna 64. A microcontroller 46 is positioned on a circuit board 48 along with an RF transmitter 50. An upper magnetic sensor 51 is positioned on an upper circuit board 80, and a lower magnetic sensor 53 is positioned on a lower circuit board 82. The tank module further includes a magnetic shield system comprising an upper magnetic shield 77 and a magnetic shield collar 78. The tank module 40 can also contain an electronic thermometer 81. The thermometer can be integral to the microcontroller 46.

The magnetic sensors are suitably high performance 2-axis magnetoresistive sensors as indicated above. The two sensors are installed parallel to one another in a co-axial fashion. Both sensors are identical, with identical sensitivities to magnetic fields. Both sensors are installed with precisely the same orientation with exactly the same angular reference point, yet are spaced a predetermined distance apart. Since magnetic field intensities weaken with increasing distance from the magnetic source, a common magnetic sensor with common magnetic sensitivity can be utilized in measuring significantly different magnetic field intensities by simply placing the sensor further from the source. The function defining the rate at which this field-strength decreases depends on the geometry of the magnetic lines of flux; however, an appropriate distance may be easily found empirically. This distance may be suitably 1.0 cm.

### Attachment Band

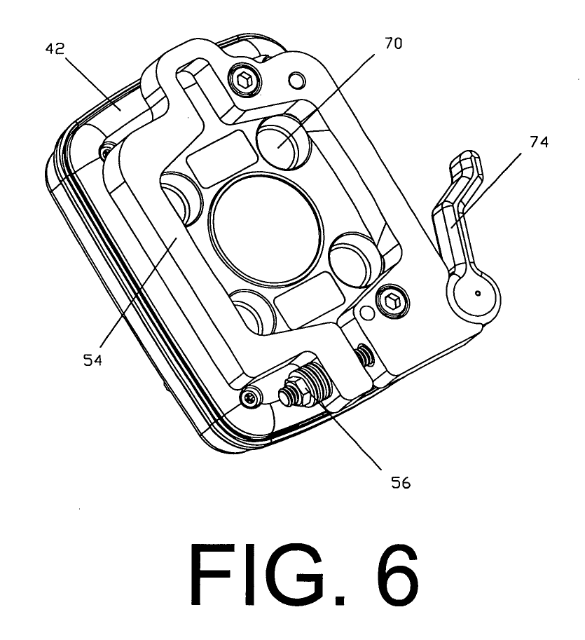

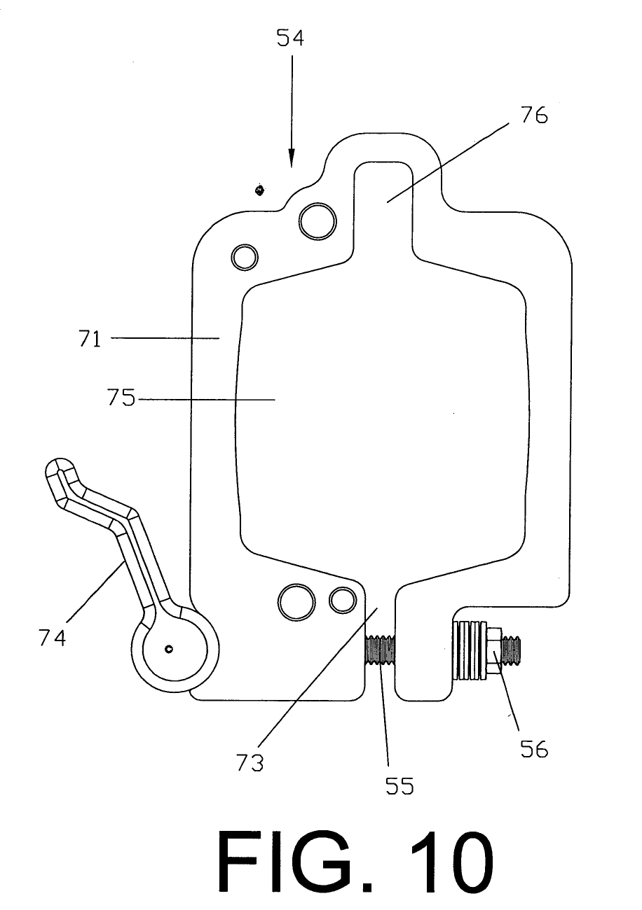

The tank module 40 is secured to the gauge 30 of the tank 12 by the attachment band 54. The attachment band is shown in FIGS. 6 and 10. The attachment band 54 comprises an adjusting bolt 55, an adjusting nut 56, a clamp lever 74 and a collar section 71 having a bottom channel 73, a main opening 75 and an upper channel 76. The attachment band 54 is tightened by means of the clamp lever 74 cam mechanism that constricts the attachment band 54 upon a clamping motion by the lever 74.

### Display Module

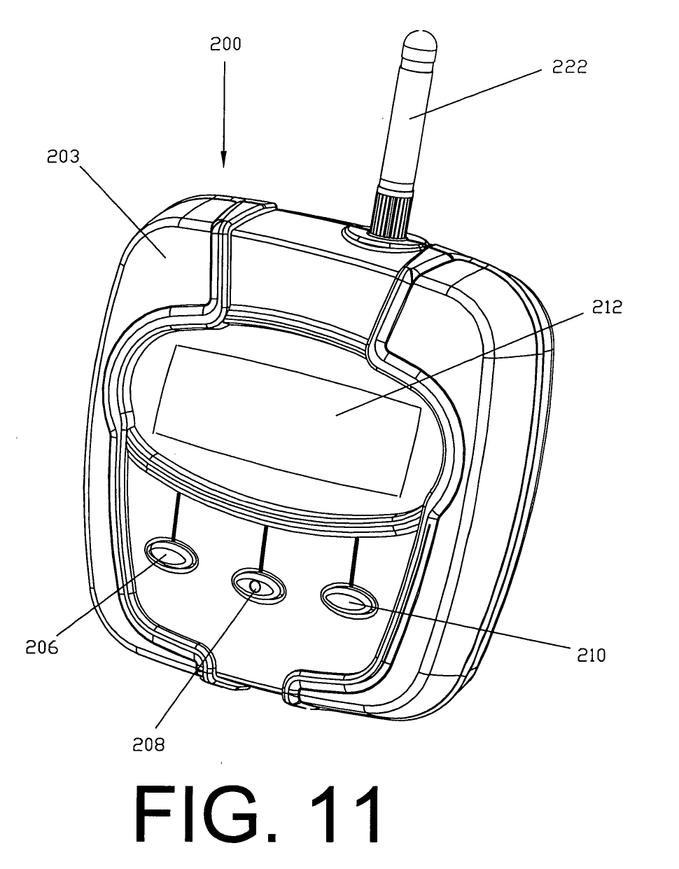

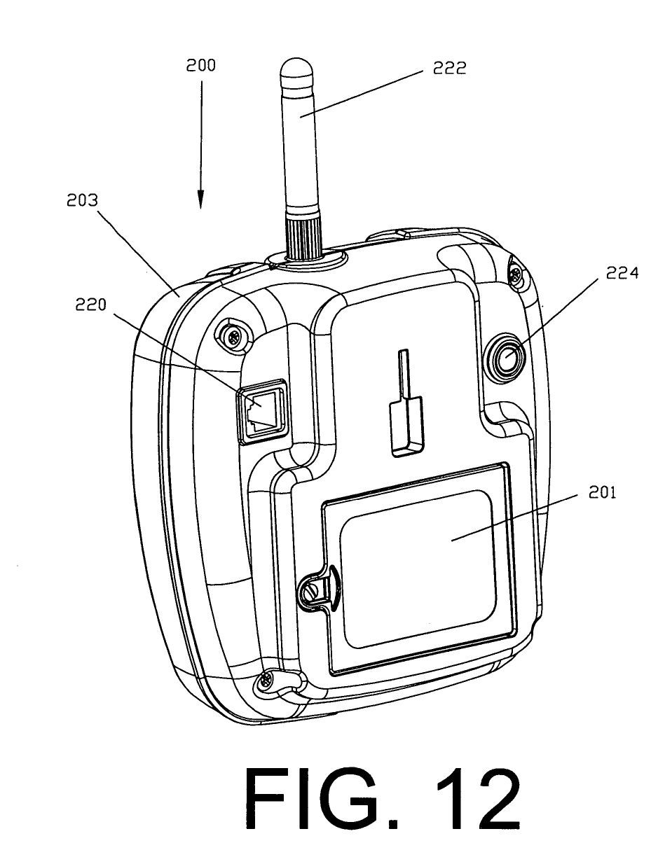

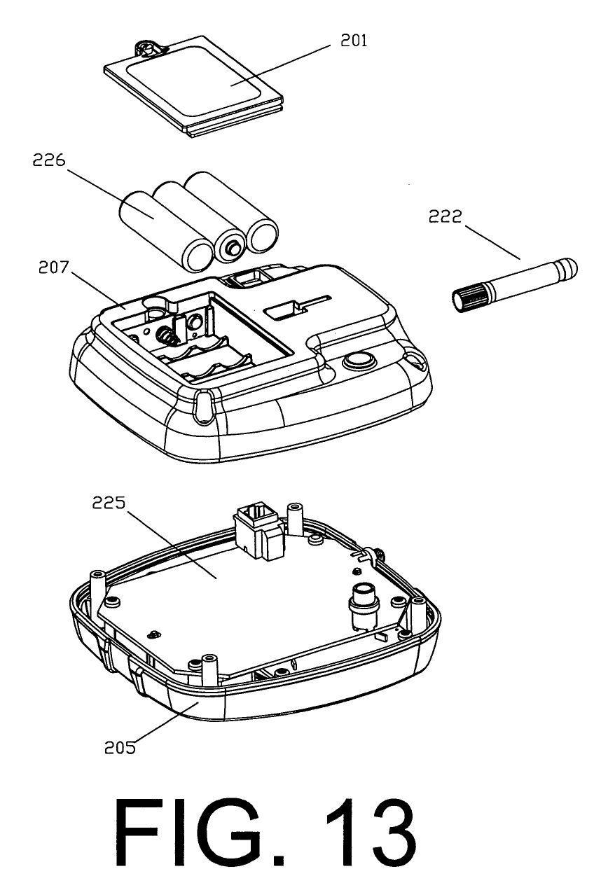

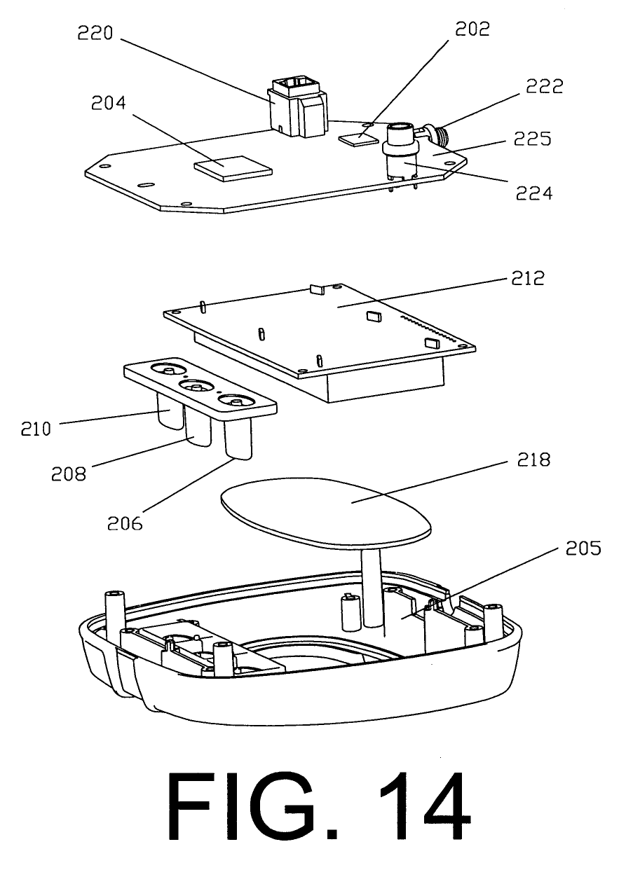

FIGS. 11-14 detail the display module 200. The display module 200 comprises a housing 203, a battery cover 201, a circuit board 225, an RF receiver 202, a microcontroller 204, input buttons 206, 208, 210, a liquid crystal display 212, an audio transducer, a power switch, a voltage regulator, a tractor groundspeed connector 220, and a clock oscillator. The display module 200 can be powered by an onboard battery 226 or by the power supply of a tractor, through a power supply input 224 in the display module 200. The display module 200 can be mounted within a tractor 10 cab. The display module 200 can be mechanically fastened either via suction cups to the windshield, a mounting holster within the cab or by magnetic means. The display module can also contain a T-slot attachment 227 to aid in mounting.

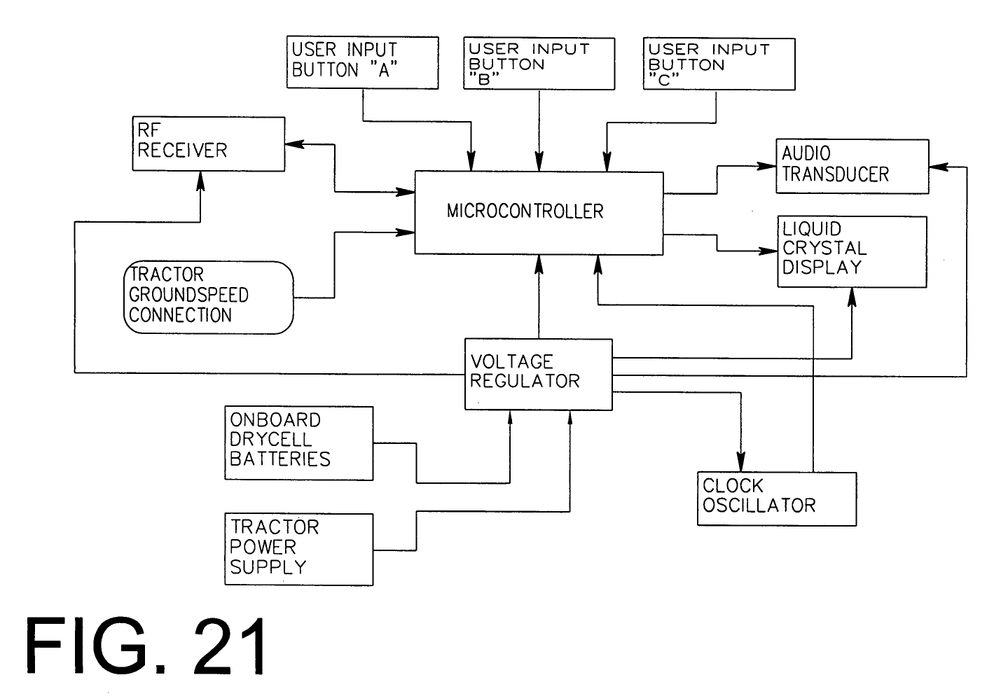

One embodiment of the physical and circuit connections of the display module 200 are detailed in FIGS. 11-14 and 21. The arrows in FIG. 21 indicate the input/output relationship between the components. A 16-bit microcontroller 204 is powered via 12V tractor supply or internal batteries 226 preferably 9V or AA batteries, within the display module housing 203. The voltage regulator regulates external voltage down to +3V for circuit components. The display module 200 can be connected to the tractor's onboard Doppler groundspeed instruments or other speed indicators to have access to the tractor's current speed for purposes of secondary calculations and features. The tractor's ground speed indicator is electronically interfaced with microcontroller 204 via a cable and appropriate connectors 220. The clock oscillator supplies a square wave at 4 MHz for timing purposes to microcontroller 204. The liquid crystal display 212 is directly interfaced with microcontroller 204 to provide visual information to the user.

Three momentary input pushbutton switches 206, 208, 210 provide means by which the user may enter relevant information pertaining to tank size and field implement width, as well as select a display mode. The input buttons 206, 208, 210 are located directly beneath the liquid crystal display 212. The function of each input button 206, 208, 210 changes depending on the point in software flow.

The RF receiver 202 interfaces directly with microcontroller 204. The audio transducer 214 provides the user with an audio alert and is powered by the +3V supply and signaled by microcontroller 204.

### Display Input Button Designation and Use

The display module 200 interfaces with the user via three general purpose input buttons 206, 208, 210. The input buttons 206, 208, 210 are located directly beneath the liquid crystal display 212. The function of each input button 206, 208, 210 changes depending on the point in software flow. Each button's 206, 208, 210 function is made known to the user by utilizing the bottom row of characters of the liquid crystal display 212 to print directly above each button 206, 208, 210 what the corresponding button will cause the display module 200 to do at various points in software flow.

In one embodiment, the display module 200 initiates operation with a welcome screen to indicate “power on” status while the internal circuitry is reset and stabilized. The welcome screen allows user to select one of two options. The left button 206 is depressed if the user wants to input tank size, implement size, or groundspeed calibration information. The right button 210 is depressed if no further information is needed to be inputted or changed from the previous use. If the left button 206 is depressed, corresponding to the word “SETUP” on the bottom row of the liquid crystal display 212 on the welcome screen, the display module 200 prompts the user to input the current size of the anhydrous ammonia tank in gallons. The display module 200 displays the current value for the tank size. If the tank size that is displayed is correct, the user depresses the center button 208 to accept the current tank size. If, however, the tank size needs to be modified, the user may use the left 206 and right 210 buttons to decrease or increase the tank size respectively. When the correct tank size is being displayed, the user depresses the center button 208 to accept the newly modified tank size. This process can be repeated in a similar fashion to input the width of the field implement.

Also in one embodiment, the user may, at the conclusion of the tank size and implement size setup screens, enter a mode by which the groundspeed radar system may be calibrated. The user depresses the left button 206, which corresponds to “START” and then drives the tractor the distance specified on the display module 200, suitably 200 feet. Once the specified distance has been covered, the user depresses the right button 210, which corresponds with “FINISH.” The display module 200 now has an absolute distance by which it can calibrate its interface with the groundspeed electronics, and this calibration is stored for future use when the display module is in monitoring mode. The user may cancel the calibration routine at any time by depressing the center button 208, which corresponds with “CANCEL.”

In another embodiment, the display module 200 is suitably setup with proper tank size, field implement size and groundspeed calibration. The user may use the left 206 and the right 210 buttons to scroll through the various display screen options. Suitably, there may be four screens: a screen that simply displays fluid level with a corresponding numerical and bar graph output, a screen that displays the flow rate of fluid and the corresponding estimated time until tank is empty, a screen that indicates the application rate per acre, and a screen that verifies inputted tank size and the amount of fluid remaining in an absolute unit, such as gallons. The number of information screens in not limited to these, however, and may also include screens that indicate total acreage covered, the current ground speed of the tractor, the date and time, a plurality of error messages indicating status of tank module or other electronics, tank empty alerts, burst hose or other messages indicating excessive flow rates that are not anticipated, the internal battery level of either the display module or the tank module, the relative error associated with application rate per acre or other information presented, a summary screen showing all current constants such as current field implement width or current tank size, the total quantity dispensed using the system in current season, the total number of acres covered in the current season, and a total cumulative average application rate per acre in the current season.

### Fluid Level Detection with a Single Magnetic Detector

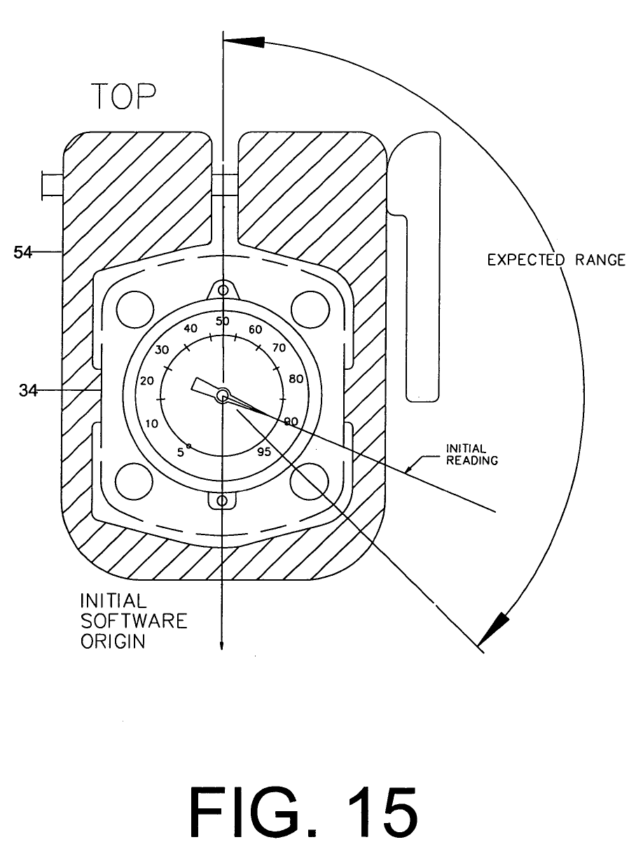

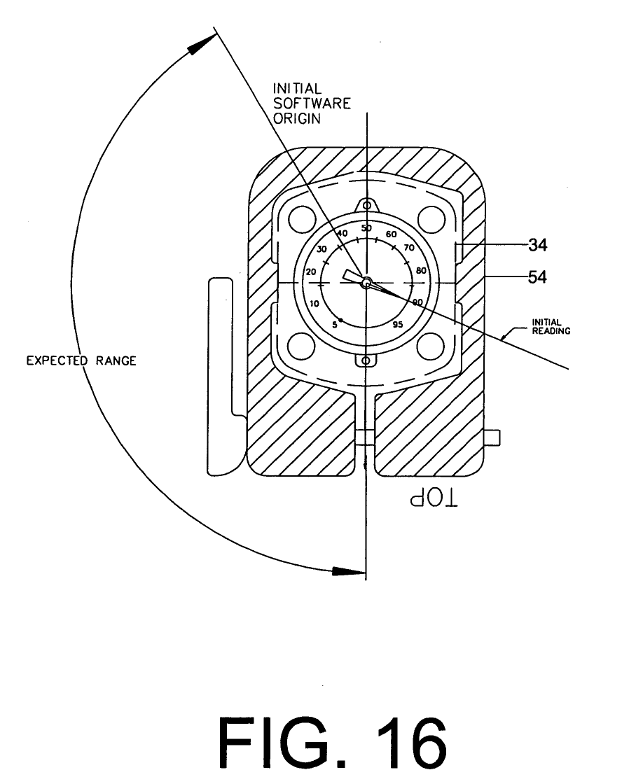

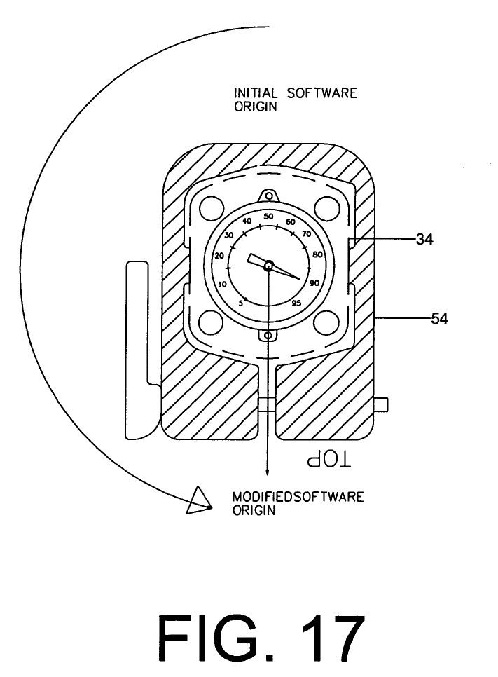

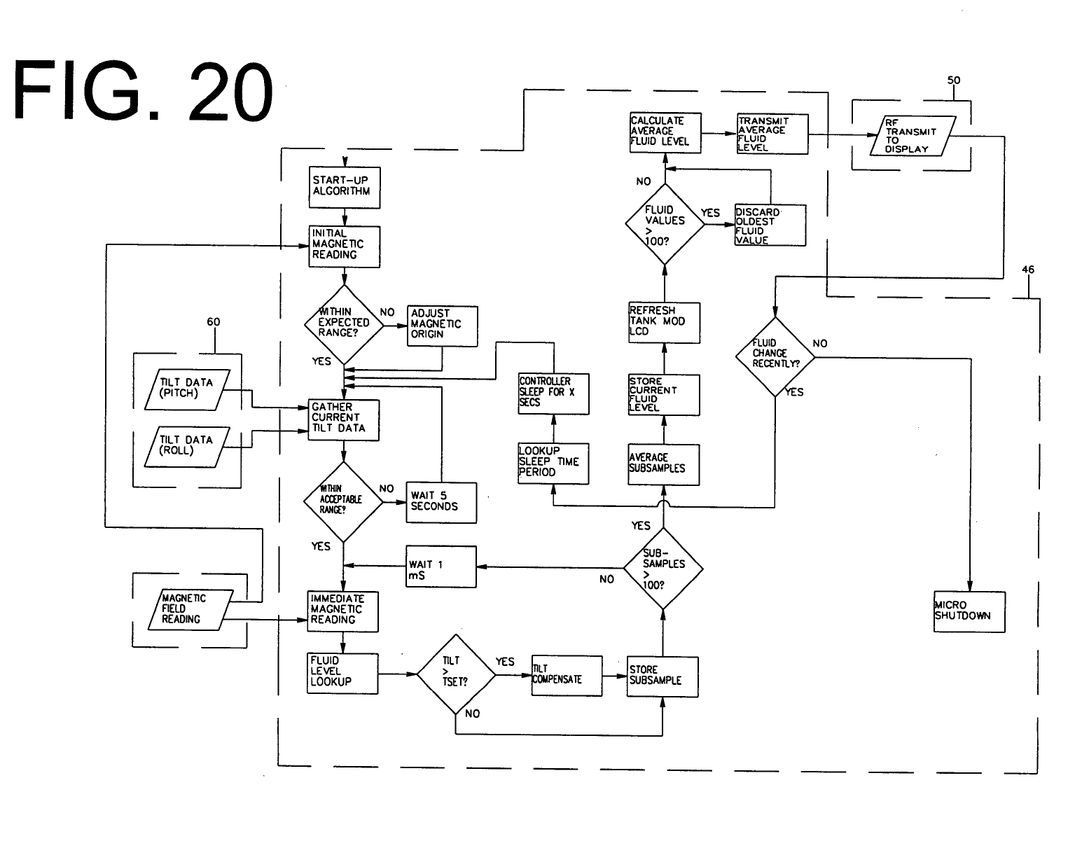

One embodiment of a process undertaken by the tank module 40 is detailed in FIGS. 3, 5-6, 11-14 and 20. After the tank module 40 is mounted to the gauge 30 of the tank 12, and the unit is powered, the microcontroller 46 goes through a start-up routine which resets the input/output devices connected to the microcontroller 46. The microcontroller 46 then pauses momentarily for the circuit to stabilize. The magnetic field sensor 52 is then interrogated by the microcontroller 46 in an initial magnetic field reading process which indicates to the microcontroller 46 the precise position of the fluid indicating needle on the face of the gauge 36. As the tank module 40 will be attached to anhydrous ammonia tank 12 most often at the beginning of the fertilizer process, when the tank 12 is freshly filled, the tank 12 should be filled to between 85-95% full. The microcontroller 46, therefore, is programmed to assume that the initial magnetic field measurement will be within a pre-set boundary that correlates to a tank that is greater than 50% full. FIG. 15 displays the angular position of the gauge 36 with respect to such an assumed start fluid level. If the initial magnetic field reading is within these preset boundaries, the process continues with the original origin setting. However, if the initial magnetic field reading is not within preset boundaries, the microcontroller 46 concludes that the tank module has been inadvertently attached to the gauge mechanism exactly 180 degrees from the desired orientation and the microcontroller 46 then automatically moves the origin point 180 degrees to be compatible with the relative orientation of the gauge 30. FIG. 16 shows the angular position of the gauge 36 when the tank module 40 is placed in the wrong orientation, and FIG. 17 shows the angular readings of the tank module after the realignment of the origin by the microcontroller 46.

The electronic inclinometer 60 is interrogated by the microcontroller 46 to detect the tank module's pitch and roll, which correlates with the anhydrous ammonia tank's 12 pitch and roll. The microcontroller 46 analyzes these tilt values to see if the field tank 12 is on sufficiently level ground to take fluid level measurements. If the pitch values are above a preset threshold, suitably above a 10% grade or 5.7 degrees from level, the microcontroller 46 “loops” for a preset time, suitably 5 seconds, and then interrogates the tilt sensor 60 again to see if the field tank 12 has moved sufficiently back to level ground as the fertilizing process is continuing. If the pitch and roll values are within preset thresholds, the microcontroller 46 interrogates the magnetic field sensor 52 to measure the immediate magnetic reading. This magnetic reading is then cross-referenced with an internal “look-up” table that correlates magnetic field orientation with an actual volumetric fluid level, based on preinstalled knowledge of the tank's geometry and gauge mechanism's behavior. The pitch data is used again to compare the field tank's 12 tilt to another pre-set threshold. If the pitch values are above the threshold, suitably a 5% grade or 2.86 degrees from level, the microcontroller 46 compensates for the pitch and roll effects on perceived fluid level value and stores the adjusted fluid level sub-sample accordingly. If the pitch values are below the threshold, the process immediately stores the fluid level sub-sample without further compensation.

A procedure to compensate for the “sloshing” of liquid in the tank is then undertaken. The microcontroller 46 compares the number of sub-samples stored at this point to a preset threshold, suitably 100 or 1000 sub-samples. If there are insufficiently few sub-samples (number of sub-samples is below the preset threshold), the microcontroller 46 waits for a preset duration of time, suitably about 1 mS, before sampling again the immediate magnetic reading and repeating the process. If there are sufficiently enough sub-samples (number of sub-samples is above the preset threshold), the microcontroller 46 averages the stored sub-samples and then stores this averaged value as the current fluid level. The microcontroller 46 then updates the liquid crystal display 62 on the tank module 40. The microcontroller 46 next compares the number of current fluid level values to a preset threshold, suitably 100 or 1000 values. If the number of stored current fluid level values is above the set threshold, the oldest value within this data set is discarded, which has the affect of incrementally updating the data set to reflect more current fluid level data.

Next, the microcontroller 46 calculates a weighted average of the fluid level values and stores this as a final moving average parameter, which is the final approximation of the fluid-level within the field tank 12. The microcontroller 46 then sends this singular fluid-level value to the RF transmitter 50 which transmits the fluid level information to the RF receiver 202 in the display module 200.

The tank module 40 circuitry automatically shuts down if fluid level information has not changed beyond a preset threshold, suitably a 2% change in fluid level within 2 hours.

Since the gauge 30 reading will change at a faster rate at the high and low portions of the tank volume relative to the mid-portions of the tank volume, the tank module 40 of the present invention allows the fluid level refresh rate to be optimized for both performance and power saving. If fluid level data has changed sufficiently within the preset threshold or the momentary switch 58 has been activated within a preset period of time, the microcontroller 46 correlates averaged fluid level data with a corresponding sleep time using another look-up table. The found sleep time value from the look-up table defines the amount of time the tank module 40 will power down until the next fluid level value will be taken, and the process repeats itself by gathering current tilt data.

### Fluid Level Detection Utilizing Two Magnetic Detectors

There exists a plurality of existing gauges used for measuring the internal fluid level for confined pressurized substances, such as anhydrous ammonia or propane. In the United States, two significant manufacturers of these gauges are Rochester Gauges, Inc. and Squibb Taylor, Inc. of Dallas, Tex. The strength of the embedded magnet can vary several orders of magnitude between dissimilar gauges. Large differences (over 10 times the amplitude) between dissimilar gauges provides a significant challenge when developing a device that will have a common design, yet be universally compatible across differing environments. When relying on a singular sensor, there is the case that a sufficiently sensitive sensor for one type of gauge will saturate in a higher magnetic field of a different style of gauge. Conversely, it is also quite possible that a sensor chosen to measure much stronger magnetic fields may not be adequately sensitive to detect a much smaller magnetic field associated with a gauge style incorporating a weaker magnet.

The present invention overcomes this difficulty by using a tank module 200 with two magnetic sensors, namely an upper 51 and lower magnetic sensor 53 as described above and shown in FIGS. 4-9.

Upon installing the tank module 200 onto the corresponding magnetic float gauge hardware 16, the microcontroller 46 interrogates the upper magnetic sensor 51. If the magnetic field intensity is above a certain minimum threshold, the upper magnetic sensor 51 is used as the active sensor. However, if the magnetic field intensity is below a certain minimum threshold, the lower magnetic sensor 53 is interrogated. If the lower magnetic sensor 53 outputs a sufficiently high output, but the upper magnetic sensor 51 does not, the lower magnetic sensor 53 is used as the active sensor. If neither the upper 51 nor the lower 53 magnetic sensor outputs a sufficiently high output value, the microcontroller 46 deduces that the tank module is not on a float gauge 16 and enters into a “sleep” mode for power conservation. Suitably any magnetic reading over 10 Gauss is handled by the upper magnetic sensor 51.

Furthermore by using the difference in the amplitude of a magnetic field between two dissimilar gauge styles, a gauge 30 can be easily identified as one type or another. This information can be used for essential calibration routines, for cases where the two different gauge styles have different graduated face markings. By first identifying the type of gauge through its magnetic field intensity “signature,” different internal reference points and look-up tables can accurately translate a given magnetic field orientation with the corresponding internal fluid level.

After the tank module 200 determines the angular position of the magnet 28, the microcontroller 46 translate the angle into an actual volumetric fluid level using a pre-established look-up table that contains the geometric relationship between the position of the magnet and the actual fluid remaining inside the tank. This look-up table may suitably contain look-up information for all fluid levels between 0% and 100% fluid volume remaining, as values outside this range are outside the measurement limits of the actual gauge, and are infrequently encountered under normal operating conditions.

### Fluid Level Detection of Multiple Tanks

In anhydrous ammonia application it is common that the application of anhydrous ammonia involves the use of multiple towed-tanks simultaneously. Most often, two anhydrous ammonia nurse tanks are mounted side-by-side to a common wagon to double the capacity of ammonia that can be carried out into the field at one time. A separate tank module 40 is mounted to each anhydrous ammonia nurse tank. By independently monitoring the fluid level of each tank separately, and the corresponding changes in fluid level, very accurate estimations can be made regarding when the system as a whole needs to be changed for full tanks and how much total fluid is being dispensed per acre. The dual-tank application tank module is essentially identical to the single-tank application tank module; however, since two tank modules are being used in very close proximity to one another, it is essential that some type of transmission “signature” be incorporated so that the receiving display module 200 can differentiate between the two tank modules. This differentiation is achieved by each tank module including a unique identification byte within each transmission. The display module then, upon reading and interpreting this unique identification byte, can easily differentiate between the two (or more) tank modules.

The dual-tank application display module 200 contains a singular radio frequency receiver 202 that detects the transmission code from each of the tank modules 40. The current fluid level, expressed as a percentage of fluid remaining, is stored in separate memory blocks within the display module microcontroller 204. On a single screen 212, each tank's current fluid level can be expressed both as a bar graph with its corresponding numerical percentage of fluid remaining in the tank. This dual-reading on a singular display 212 would prove extremely useful for farmers monitoring the flow rates from each tank, and would alert the farmer if the fluid level between the tanks was above a normal threshold, which may be indicative of problems on the application equipment.

### Use of a Magnetic Field Insulator to Isolate Local Field From Earth's Magnetic Field

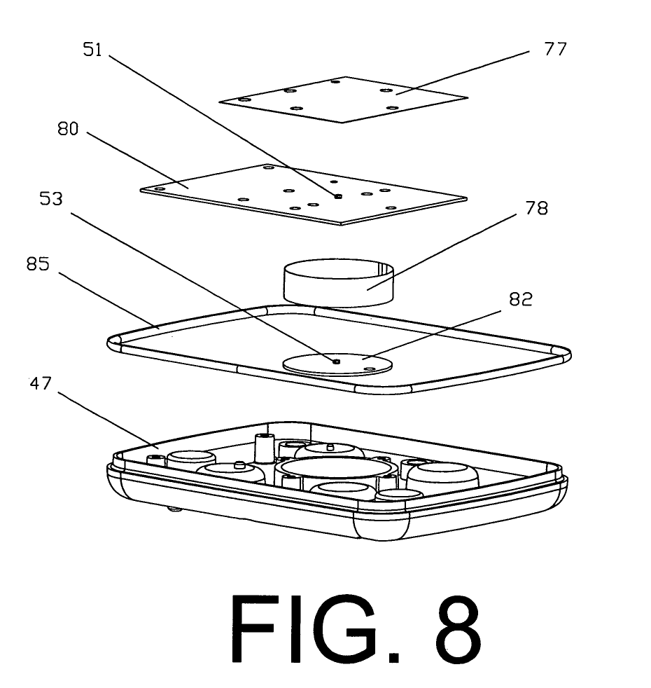

The fluid level detection system relies upon the local magnetic field generated by an embedded magnet 28 within the existing float gauge hardware 16. External magnetic fields not associated with the float gauge 16 can introduce errors in the fluid level measurement. To alleviate this potential for magnetic field interference, the invention provides a magnetic shield system (FIG. 8). The magnetic shield system comprises an upper magnetic shield 77 and a magnetic shield collar 78. The upper magnetic shield 77 may be suitably mounted to the top-side of the upper circuit board 80 that contains the upper magnetic sensor 52. The magnetic shield collar 78 may be suitably inserted into a custom cylindrical cavity within the injection molded lower housing 47 of the tank module 40, such that the bottom edge of the magnetic shield collar 78 contacts the bottom of the cavity, and the top edge contacts the upper circuit board 80. This configuration creates a cylindrical magnetically shielded cavity whereby both the upper 51 and lower 53 magnetic sensors are magnetically isolated from any external fields. The bottom is left open to allow the local magnetic field from the float gauge face 36 to enter the cavity and affect the magnetic sensors 51 and 53 for the purpose of fluid level detection.

The cylindrical cavity within the interior of the magnetic shield may be suitably filled with a nonferrous potting compound to bind the whole magnetic sensing module together, and guard against moisture, vibration, dust and tampering by the user. The potting compound may be injected in liquid form after the final assembly of the magnetic sensing module through one or two holes in the upper circuit board 80, and allowed to cure to a solid or elastomer state.

### Determination of Fluid Level Compensation Due to Pitch and Roll

The tank module 40 (FIGS. 3-9) is capable of measuring both pitch and roll measurements of the tank's 12 angle of incidence relative to the ground plane by means of a 2-axis electronic inclinometer 60. Since most internal gauge mechanisms are mounted axially within the field tank 12, the pitch of the field tank 12 will have by far the largest effect on possible measurement errors associated with uneven terrain, as opposed to roll which would be encountered frequently in contour farming and does not have a significant effect on float position. The tank module 40 compensates for erroneous float positions due to pitch inclines or declines by combining the information from the electronic inclinometer 60 with the current averaged fluid level.

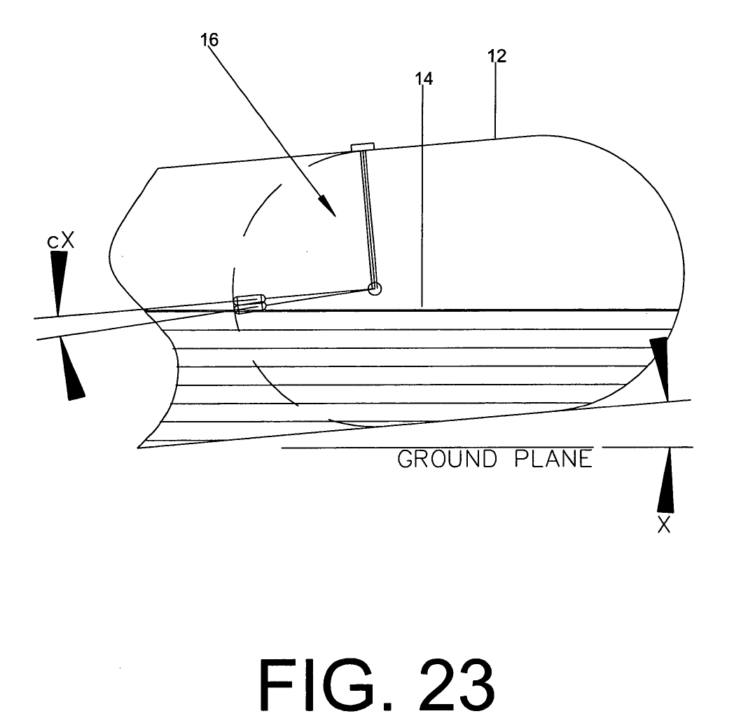

FIG. 23 details a fluid containing tank on an incline. As the tank goes up a hill, for instance, the inclinometer 60 will measure the angle of the field tank relative to the ground plane. This pitch angle, angle X, is proportional to the error in the float arm position angle cX. The relative effect a given incline or decline will have on the error in the float position is highly dependant upon the amount of fluid remaining in the tank. For an incline, for instance, any given incline angle will have a much more profound effect on float position error for a mostly empty tank than a mostly full tank. Fortunately, however, this behavior is perfectly consistent and predicable, and therefore, information in the form of a look-up table of conversion equation may be stored in the tank module's memory. The angle of tilt defines a coefficient “c” that is multiplied by the inclinometer 60 reading angle X to compensate for the difference in float arm position. The angular difference in float arm position can then be directly correlated to the assumed error in the magnetic field reading using the preinstalled gear ratio information between float arm position and permanent magnet position. The resulting calculated error at the permanent magnet is then simply added or subtracted from the actual reading, and therefore, a compensated fluid level is found.

### Calculation of Quantity of Fluid Dispensed by Volume

Fluid level information received from the tank module is stored in a memory bank within the display module microcontroller. A table of fluid level values at various points in time is generated, and permits the calculation of the total quantity of fluid dispensed to farmland to be generated based on the microcontroller's 204 calculation of the difference between the fluid level at start of process and the current fluid level by the use of the following algorithm:

Quantity dispensed=(% at start−% currently)×total tank size.

### Calculation of Quantity of Fluid Dispensed by Mass

The present invention allows for the physical characteristics of a specific fluid to be preprogrammed into the control software to allow subsequent information to be displayed in a manner most convenient for the user.

In one embodiment the invention can be customized for anhydrous ammonia by programming the physical constants of the fluid into the software of the fluid detection system.

Farmers are mainly interested not in the actual volume of material dispensed, but rather in how that correlates to a targeted application rate in terms of actual nitrogen. The physical density of liquid anhydrous ammonia in a confined vessel at 60° F. is 5.15 lb/gallon. Introducing this coefficient into the quantity dispensed equation yields an output in the mass of material applied (assuming Earth's constant for acceleration due to gravity), rather than volume.

The atomic weight of nitrogen and hydrogen are 14 and 1, respectively. With knowledge of the ratio between nitrogen and hydrogen atoms, the molecular concentration of nitrogen in anhydrous ammonia, by weight, can be calculated:

Concentration of nitrogen by weight in anhydrous ammonia=((atomic weight of nitrogen)*(1 atom of nitrogen))/((atomic weight of nitrogen)*(1 atom of nitrogen)+(atomic weight of hydrogen)*(3 atoms of hydrogen))=(14*1)/((14*1)+(1*3))=14/17 or ˜0.8235.

With this second coefficient representing the concentration of nitrogen, by weight, in anhydrous ammonia, a direct conversion from change in fluid level to actual pounds of nitrogen can be made using a modified equation:

Quantity of lbs. Nitrogen dispensed=(% at start−% currently)×(total tank size)×(density coefficient of NH3)×(concentration coefficient for N in NH3)

While the physical constant of the concentration of nitrogen in anhydrous ammonia is an absolute constant that does not vary by definition, the physical mass density of anhydrous ammonia does; however it fluctuates given different temperature and pressure factors.

A predictable and well-established relationship exists between the temperature of a confined vessel of anhydrous ammonia, and the corresponding density of the contained liquid. As the temperature of the anhydrous ammonia liquid increases, the density correspondingly decreases in a relatively linear relationship. Charts numerically summarizing this physical relationship are widely established and publicly available.

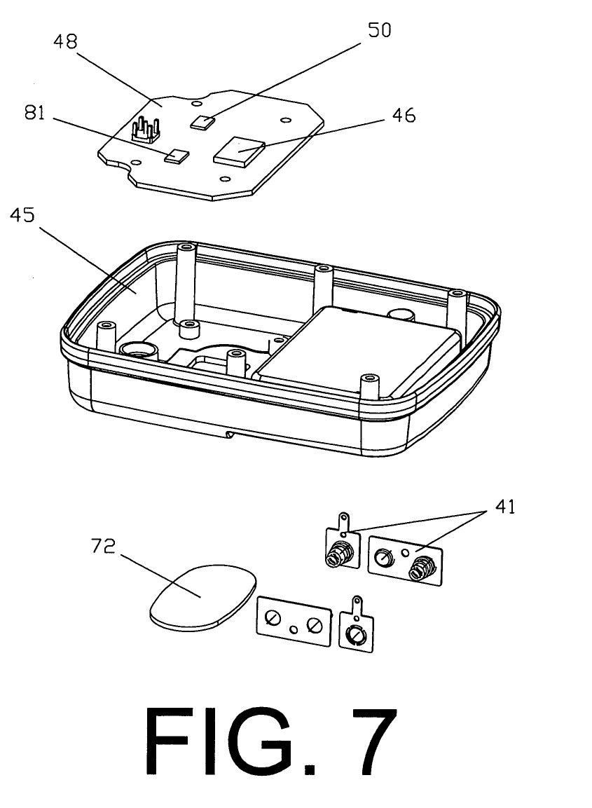

In one embodiment of the invention an internal thermometer 81 (FIG. 7) is integrated within the control make-up of the tank module. This electronic thermometer can be suitably a discrete component interfaced with the existing hardware found in the tank module, or it can be an integral feature of an existing component, namely the microcontroller 46 itself.

As an example, a MSP430F flash microcontroller manufactured by Texas Instruments can be utilized as the processor for the tank module. A chip such as the MSP430F contains on-chip peripheral features, such as temperature measurement of the printed circuit board. This functionality is suitable to gauge the ambient temperature of the tank module system, and thus a better approximation of the operating temperature of the anhydrous ammonia fluid.

In such an application, the on-chip thermometer can be interrogated for the local temperature. Assuming the temperature of the anhydrous ammonia liquid is near that of ambient temperature, a direct assumption is made that the temperature of the anhydrous ammonia liquid is known. In internal look-up table cross-references the ambient temperature with the corresponding density of liquid anhydrous ammonia is substituted into the defining equation that correlates a change in fluid level to the mass of anhydrous ammonia being applied.

With this increased functionality, the user can safely assume that the displayed information has been temperature compensated for the current environment. Regardless of whether the user is applying chemical on a cold fall night or at high noon in the summer, the system responds with appropriate compensation.

### Calculation of Acres Covered

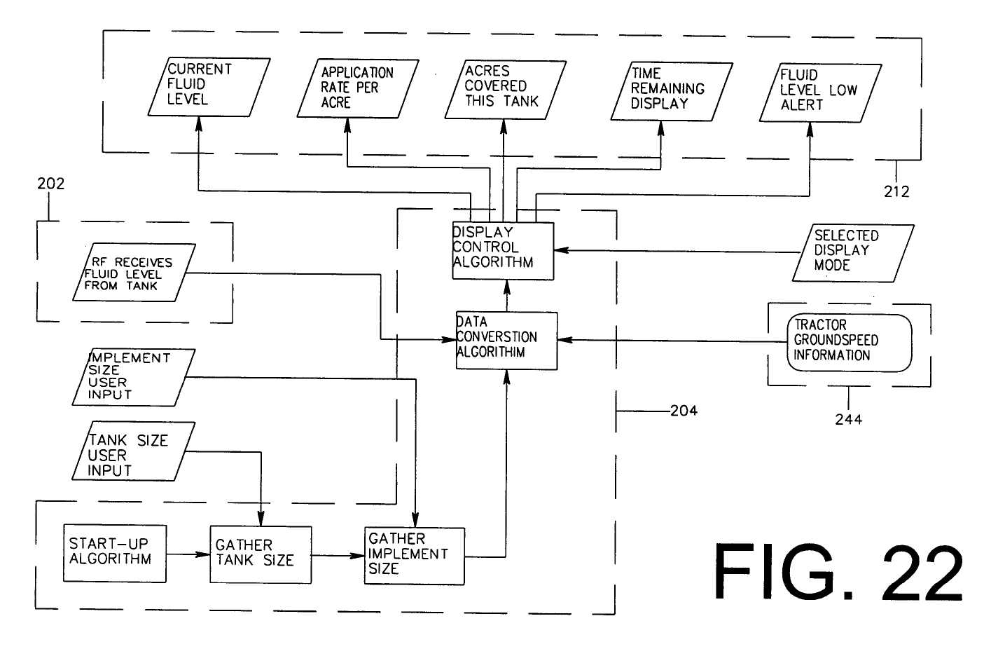

In one embodiment of the invention, the invention provides a method for the automatic calculation of aces covered. As shown in FIGS. 11-14 and 22, the user initiates the display module 200 by pressing a button 208, at which time the display module microcontroller 204 and support circuitry go through a start-up algorithm whereby the various components are reset, and an audible alert is made by the audio transducer. This indicates that the unit has power and the microcontroller 204 initiates a brief welcome message on the liquid crystal display 212. The user is then prompted with a request to input the total capacity of the anhydrous ammonia tank in gallons. The user may select one of several standard anhydrous ammonia field tank sizes: 1000, 1450, 1800 and 2000 gallon sizes, or may enter another size manually. Once an appropriate tank size has been entered, the user is prompted with a request for the field implement width. The user enters the implement width by selecting one of several common field implement widths or enters manually an implement width not offered as a choice. The anhydrous ammonia field tank volume input and the application implement width represent system constants and do not change during the application period.

The microcontroller 204 then moves into a continuous data acquisition and processing mode and outputs desired information to the user. This information is updated regularly. Periodic updates on the current fluid level are broadcasted to the display module via a radio frequency transmission from the tank module's RF transmitter 50 and are received by the RF receiver 202. Periodic fluid level information is stored within the microcontroller 204 memory banks along with an associated time that the fluid level data was acquired. Simultaneously, current groundspeed data is gathered from the tractor's groundspeed electronics 244.

The vast majority of installed tractor groundspeed radar systems output a square wave “pulse” that corresponds to the amount of distance traveled in the field. Each pulse corresponds with some arbitrary, yet constant, amount of linear distance traveled in the field. A separate calibration routine is used to establish a coefficient that equates a given number of pulses to a more usable unit of measure, such as feet or miles. The display module 200 captures and counts the number of pulses outputted by the groundspeed radar device 244, and then uses a predefined calibration constant to translate these counted pulses into a unit of measure that is more understandable to the user. Tractor groundspeed information is combined with the width of the application field implement to calculate total area covered by the application process by utilization of a simple multiplication algorithm:

Acres covered [acres]=(Number of pulses counted [pulses])×(Groundspeed calibration coefficient [feet/pulse])×(Width of the Application Implement [feet])×(Unit conversion coefficient [acres/feet²])

In another embodiment the user directly inputs the number of acres covered into the display module. The three-button interface is sufficient for such entry of data by utilizing a similar methodology as input of tank size information. Suitably, the left 206 button decrements the displayed acres covered figure by 0.1 acres, while the right button 210 increments the displayed acres covered figure by 0.1 acres. Upon reaching the desired acres covered number, the user depresses the center button 208 to confirm and proceed to the calculation.

The amount of acres covered can be used in calculations relating to application rate per acre and mass of fluid dispensed per acre.

### Calculation of Average Application Rate Per Acre

The display module microcontroller 204 (FIGS. 11-14 and 22) also calculates the average application rate per acre using the following algorithm:

Average application rate per acre=Total Quantity/Total Acres Covered.

The fluid level tables contain information on the time each fluid level data point was taken. By calculating the difference between two fluid level values and comparing this difference to the corresponding difference in time, a ratio is found that corresponds to the rate of drain within the tank. Once the drain rate has been established, current fluid levels can be extrapolated to determine future fluid levels based on a constant rate of drain. Based on this data the microcontroller 204 can determine the estimated time at which the fluid level will reach zero.

Through the manipulation of the various inputs into the display module 200, the microcontroller 204 calculates continuous values for the following parameters: current fluid level, application rate per acre, acres covered, and time remaining until tank is empty. These four values may be displayed on the liquid crystal display 212 as the display control algorithm receives information from user on the desired mode of display by the input buttons 206, 208, 210.

Additionally, when the tank 12 reaches a predetermined low fluid level, suitably below 5%, the liquid crystal display 212 alerts the user that fluid level is low and is accompanied by an audible alert produced by the audio transducer 214. The audio alert may be disarmed by the user.

### Determination of “Sleep Time” Between Fluid Level Readings

In another embodiment the microcontroller varies the amount of time it sleeps between fluid level samples depending on the amount of fluid remaining in the tank as a means to conserve battery power, while enhancing performance and accuracy of fluid level measurements.

It is known, based on the cylindrical geometry of the tank, that for any given flow rate of fluid from the field tank, that the rate of movement of the float arm will be greater at the upper and lower portions of the tank than it will be in the mid-section. This is because most of the volume of the tank is contained within the mid-section of the tank, so there is a smaller change in fluid level for any given quantity of fluid dispensed. The sampling rate, or duration of time that the microcontroller “sleeps” between samples, is selected from a look-up table within the tank module's onboard memory. Suitably, ten different sample periods are available to the microcontroller depending on the fluid level remaining within the tank. The sleep time periods utilized in the present invention are delineated in Table 1.

TABLE 1

| Fluid Level | Sleep Time |
|---|---|
| 90-100% | 5 sec |
| 80-90% | 10 sec |
| 70-80% | 15 sec |
| 60-70% | 20 sec |
| 50-60% | 25 sec |
| 40-50% | 25 sec |
| 30-40% | 20 sec |
| 20-30% | 15 sec |
| 10-20% | 10 sec |
| 0-10% | 5 sec |

### Flow Control System

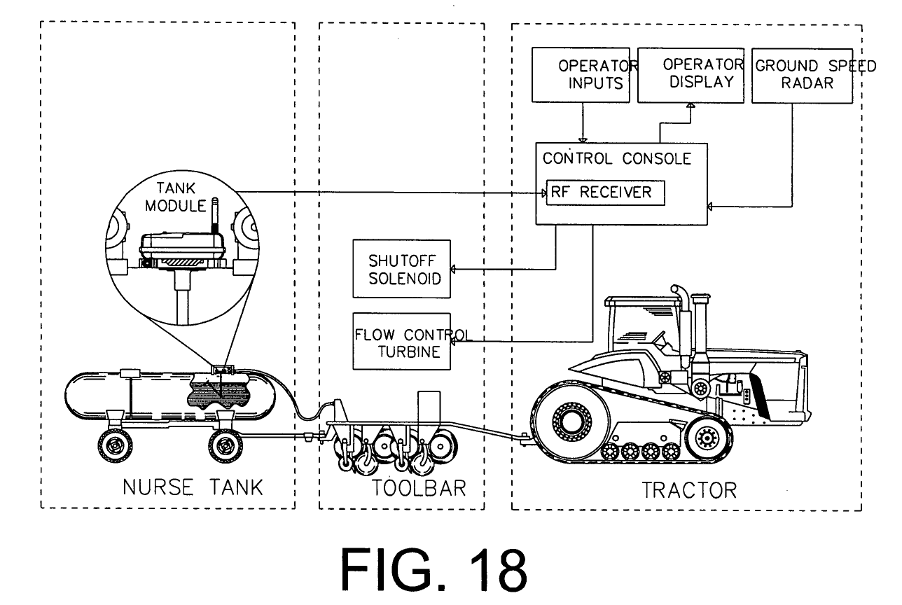

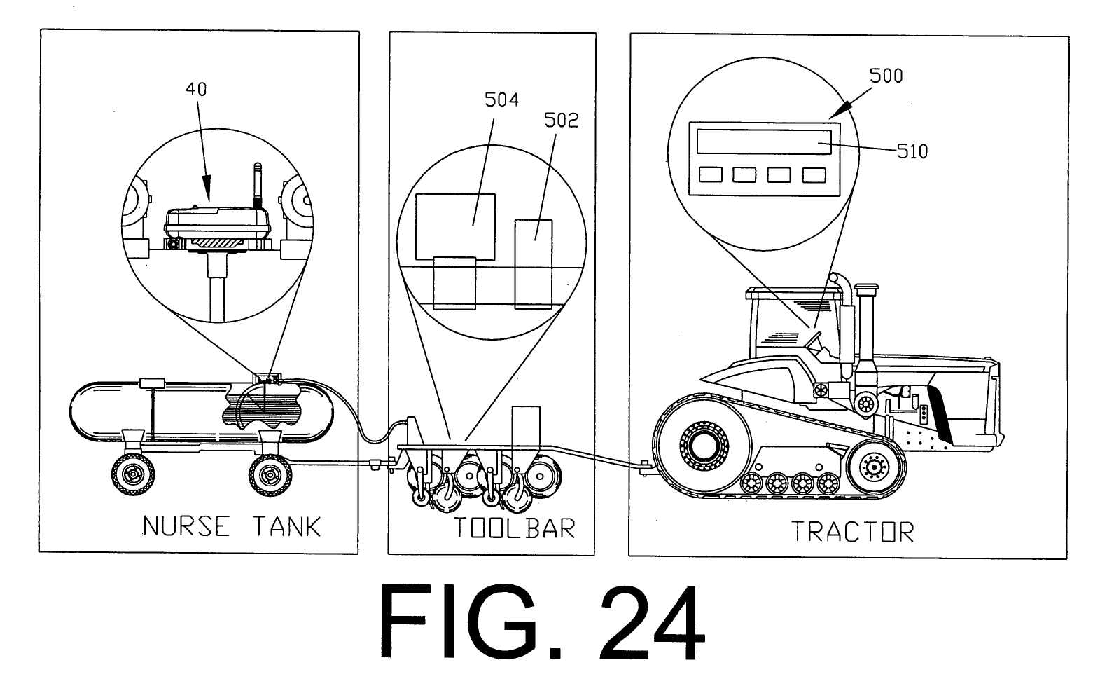

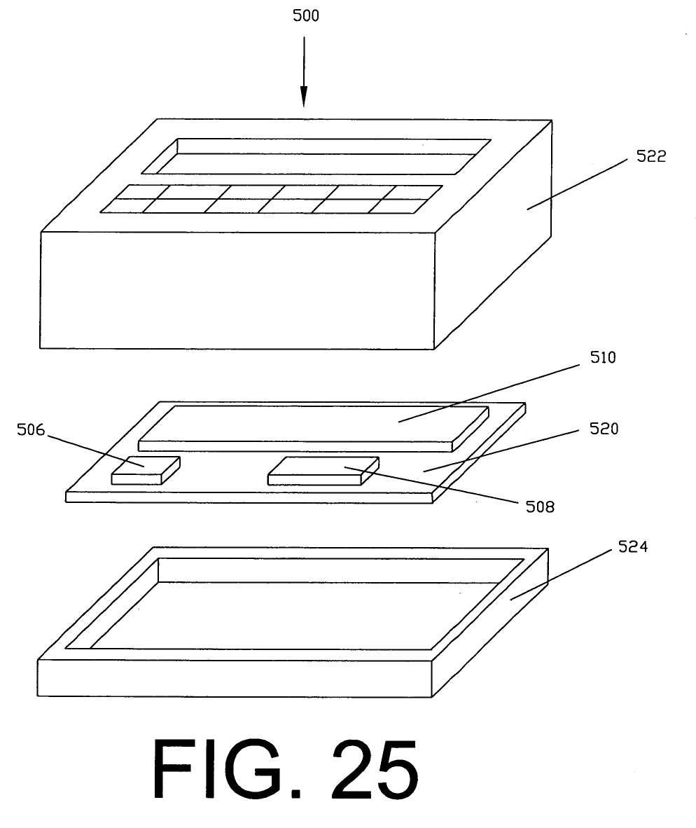

In another embodiment of the invention the tank module is integrated with a flow control system (shown in FIGS. 18 and 24-25). Many flow control systems are available on the market today, such as the Raven 440 flow control system, or those shown in U.S. Pat. No. 6,422,162 and U.S. Pat. No. 6,067,917 (incorporated herein by reference). Many of the commercially available flow control systems are electronic flow control systems. In an electronic flow control system an electronic control console is mounted within the tractor cab and hardwired to electronic solenoids, and flow control turbines are mounted to the application toolbar. The electronic flow control system has an electronic interface with the tractor's groundspeed radar system so that it can gain information on the distance traveled by the application equipment per unit time. This speed input may be coupled with a preset application rate per acre to constantly vary the flow rate of anhydrous ammonia as the tractor changes speed during application. The user also has the ability to change application rate per acre settings from within the tractor cab using the control console.

The standard electronic flow control system is modified to contain an integral radio frequency receiver that is receptive to the signal the tank module transmits, suitably 418 MHz. Software and supporting electronic hardware present in the display module are integrated into the electronic flow control console to permit information on the current average fluid level inside the towed anhydrous ammonia tank to be available to the flow control system. The control console can then display all of the information that can be calculated or displayed by the display module of the fluid detection system of the invention.

In one embodiment of the invention the flow control system comprises a tank module 40, a control console 500, a flow control turbine 502 and a shutoff solenoid 504. The tank module comprises a magnetic sensor 52, a microcontroller 46, a radio transmitter 50, a housing 42 and an attachment band 54. The control console 500 comprises a radio receiver 506 having an upper 522 and lower 524 half, a microcontroller 508 and a display 510.

In addition to the previously stated primary advantages of this integration, many other advantages exist. Since the wireless fluid level feedback, and the calculations that result from this feedback, provide the best means to verify the actual application rate, new relative error calculations can be made to diagnose faulty flow control operation. Electronic flow control systems very often malfunction, and early diagnosis of these problems will lead to significantly better material management. For instance, the following equation is proposed to calculate the relative error of the flow control device, as benchmarked against the actual fluid level feedback system:

% Error Flow Control=(MA_{—}FC−MA_{—}FLF)/(MA_{—}FLF)

where,

% Error Flow Control≡relative error between the amount of material the electronic flow control system from the fluid level feedback system reports being applied.

MA_FC≡Material Applied according to Flow Control system=integration of FLOW RATE over SAMPLE PERIOD to yield absolute quantity of material dispensed.

MA_{—}FLF≡Material Applied according to Fluid Level Feedback system=(change in fluid level on a volumetric percentage basis)×(total capacity of towed nurse tank).

For the above equation SAMPLE PERIOD is defined by the same time duration between the initial starting fluid level reference point and the ending fluid level reference point used to establish total quantity of material applied in the fluid level feedback system. FLOW RATE is defined as mass of liquid anhydrous ammonia (or other fluid) per unit time. For situations when the flow control system is not delivering fluid, FLOW RATE=0, and therefore has no cumulative effect on the MA_FC total when integrated over time.

In addition to providing useful alerts to the operator relating to low fluid level situations, yet another useful warning is proposed which alerts the operator to when the relative error between the electronic flow control system and the fluid level feedback system exceeds a preset threshold, suitably 10% relative error. Such a situation would be highly indicative of a malfunction of the electronic flow control system, and warrants operator attention. An ongoing separate display screen could, at the operators option, constantly update and display the relative error of the electronic flow control system so that trends can be noted prior to and after such alerts take place.

Another benefit the invention provides is the automatic shutoff of the flow control turbine 502 when the tank reaches a low level. Flow control systems rely on controlled turbine 502 placed in-line between the tank 12 and the application equipment to vary the flow rate through the supply lines. These turbines are designed to only deliver liquid anhydrous ammonia. When tanks 12 are inadvertently drained too far, however, gaseous ammonia from the bottom of the tank is delivered through the flow control turbines 502 causing them to turn many times faster than normal and it often leads to failure of the turbine. A replacement of this part is many hundreds of dollars. The present invention provides a method whereby when a certain low fluid level is detected by the tank module 40, suitably 2% of the tank remaining, the control console directs a shutoff solenoid 504 to turn off the flow to the flow control turbine 502, therefore preventing this maintenance expense.

While the present invention has now been described and exemplified with some specificity, those skilled in the art will appreciate the various modifications, including variations, additions, and omissions, that may be made in what has been described. Accordingly, it is intended that these modifications also be encompassed by the present invention and that the scope of the present invention be limited solely by the broadest interpretation that lawfully can be accorded the appended claims.

1. A fluid level detection system for use with a tank containing a fluid, comprising:
a first tank module, wherein the first tank module comprises a lower magnetic sensor, an upper magnetic sensor, a microcontroller, a radio transmitter, and a housing.

2. The fluid level detection system of claim 1 wherein the lower and upper magnetic sensors of the first tank module are 2-axis magnetoresistive sensors.

3. The fluid level detection system of claim 1 wherein the first tank module further includes a magnetic shield system.

4. The fluid level detection system of claim 1 wherein the tank module further includes an attachment band.

5. The fluid level detection system of claim 4 wherein the attachment band comprises an adjusting bolt, a clamp lever and a collar section having a bottom channel, a main opening and an upper channel.

6. The fluid level detection system of claim 1 wherein the first tank module further includes an electronic thermometer.

7. The fluid level detection system of claim 6 wherein the electronic thermometer is integral to the microcontroller.

8. The fluid detection system of claim 1 further comprising a second tank module, wherein the second tank module comprises a lower magnetic sensor, an upper magnetic sensor, a microcontroller, a radio transmitter, and a housing.

9. The fluid detection system of claim 1 further comprising a display module comprising a radio receiver, a microcontroller, a display and a housing.

10. The fluid detection system of claim 8 further comprising a display module comprising a radio receiver, a microcontroller, a display and a housing.

11. A method of detecting a fluid level in a tank using the fluid detection system of claim 9 comprising;
attaching the first tank module to a first tank having a magnetic float gage assembly which includes a magnet;
detecting, by the use of the lower magnetic sensor, the magnetic field intensity of the magnet, if the intensity is above a set threshold the microcontroller of the first tank module uses the upper magnetic sensor to determine the angular position of the magnetic field of the magnet, if the intensity is below the set threshold, the microcontroller of the first tank module uses the lower magnetic sensor to determine the angular position of the magnetic field of the magnet; and
determining the fluid level in the tank by the use of the first tank module microcontroller, based on the angular position of the magnetic field detected.

12. A method of detecting and displaying a fluid level in a tank using a fluid detection system comprising;
detecting the fluid level in a tank according to the method of claim 11;
transmitting the fluid level determined by the tank module to the display module by the use of a radio frequency transmission; and
displaying the fluid level in the tank on the display of the display module.

13. A method of calculating the application rate per acre of fluid dispensed from a tank comprising;
detecting the fluid level in the tank and transmitting it to the display module according to the method of claim 12;
entering the amount of acres covered into the display module via input buttons on the display module; and
calculating the application rate per acre by use of the display module microcontroller.

14. A method of calculating the mass of fluid dispensed from a tank comprising;
detecting the fluid level in the tank at a start point and transmitting it to the display module according to the method of claim 12;
detecting the fluid level in the tank at an end point and transmitting it to the display module according to the method of claim 12;
determining the ambient temperature of the tank by the use of an electronic thermometer which is included in the tank module;
transmitting the temperature of the tank to the display module;
calculating the volume of liquid dispensed by the difference in volume between the fluid level at the start point and the fluid level at the end point;
calculating the density of liquid anhydrous ammonia at the ambient temperature; and
calculating the mass of fluid dispensed from the tank.

15. A method of detecting the average fluid level in a tank:
detecting the fluid level in the tank at a first time according to the method of claim 11;
detecting the fluid level in the tank at a second time according to the method of claim 11; and
calculating an average fluid level using the fluid level at the first time and the fluid level at the second time.

16. A method of detecting and displaying a fluid level in at least two tanks using the fluid detection system of claim 10 comprising;
attaching the first tank module to a first tank having a magnetic float gauge assembly which includes a magnet;
detecting, by the use of the lower magnetic sensor of the first tank module, the magnetic field intensity of the magnet of the first tank, if the intensity is above a set threshold the microcontroller of the first tank module uses the upper magnetic sensor of the first tank module to determine the angular position of the magnetic field of the magnet of the first tank, if the intensity is below the set threshold, the microcontroller of the first tank module uses the lower magnetic sensor of the first tank module to determine the angular position of the magnetic field of the magnet of the first tank;
determining the fluid level in the first tank by the use of the first tank module microcontroller, based on the angular position of the magnetic field detected;
transmitting the fluid level determined by the first tank module microcontroller to the display module by the use of a radio frequency transmission having a first signature indicator;
attaching the second tank module to a second tank having a magnetic float gauge assembly which includes a magnet;
detecting, by the use of the lower magnetic sensor of the second tank module, the magnetic field intensity of the magnet of the second tank, if the intensity is above a set threshold the microcontroller of the second tank module uses the upper magnetic sensor of the second tank module to determine the angular position of a magnetic field of the magnet of the second tank, if the intensity is below the set threshold, the microcontroller of the second tank module uses the lower magnetic sensor of the second tank module to determine the angular position of the magnetic field of the magnet of the second tank;
determining the fluid level in the second tank by the use of the second tank module microcontroller, based on the angular position of the magnetic field detected;
transmitting the fluid level determined by the second tank module microcontroller to the display module by the use of a radio frequency transmission having a second signature indicator; and
displaying the fluid level in the first and second tank on the display of the display module.

17. A method of determining the application rate per acre for at least two tanks comprising:
detecting the fluid level in the first tank at a first and second time and transmitting it to the display module according to the method of claim 16;
detecting the fluid level in the second tank at a first and second time and transmitting it to the display module according to the method of claim 16;
entering the amount of acres covered into the display module via input buttons on the display module; and
calculating the application rate per acre.

18. A method of calculating the mass of fluid dispensed from at least two tanks comprising;
detecting the fluid level in the first tank at a start point and transmitting it to the display module according to the method of claim 16;
detecting the fluid level in the first tank at an end point and transmitting it to the display module according to the method of claim 16;
detecting the fluid level in the second tank at a start point and transmitting it to the display module according to the method of claim 16;
detecting the fluid level in the second tank at an end point and transmitting it to the display module according to the method of claim 16;
determining the ambient temperature of the first tank by the use of an electronic thermometer which is included in the tank module;
transmitting the temperature of the tank to the display module;
calculating the volume of liquid dispensed by the difference in volume between the fluid level at the start point and the fluid level at the end point of the first and second tanks;
calculating the density of liquid anhydrous ammonia at the ambient temperature; and
calculating the total mass of fluid dispensed from the first and second tanks.

19. A flow control system comprising;
a tank module comprising a magnetic sensor, a microcontroller, a radio transmitter, and a housing;
a control console comprising a radio receiver, a microcontroller and a display;
a flow control turbine; and
a shutoff solenoid.

20. The flow control system of claim 19 wherein the tank module further includes an attachment band.

21. The flow control system of claim 20 wherein the attachment band comprises an adjusting bolt, a clamp lever and a collar section having a bottom channel, a main opening and an upper channel.

22. A method of detecting a fluid level in a tank using the flow control system of claim 19 comprising;
attaching the tank module to the tank, the tank having a magnetic float gauge assembly which includes a magnet;
detecting, by the use of the magnetic sensor, the angular position of the magnetic field of the magnet; and
determining the fluid level in the tank by the use of the tank module microcontroller, based on the angular position of the magnetic field detected.

23. A method of detecting and displaying the fluid level in a tank using a flow control system of comprising;
detecting the fluid level in a tank according to the method of claim 22;
transmitting the fluid level determined by the tank module microcontroller to the control console by the use of a radio frequency transmission; and
displaying the fluid level in the tank on the display of the control console.

24. A method of determining the application rate of fluid using a flow control system, comprising;
detecting the fluid level in the tank at a first time according to the method of claim 22;
detecting the fluid level in the tank at a second time according to the method of claim 22;
determining the difference in fluid level between the first time and second time; and
determining the application rate of the fluid.

25. A method of alerting a user to an error in the application rate of a flow control system comprising;
determining an actual fluid application rate by the method of claim 22;
storing a programmed application rate of the flow control system;
determining the difference between the programmed application rate and the actual application rate; and
alerting the user on the display of the control console of the existence of a difference between the programmed application rate and the actual application rate.

26. A method of automatically shutting off a flow of fluid from a tank using a flow control system comprising:
detecting the fluid level in the tank according to the method of claim 22;
setting a shut off fluid level at which the control console signals the shutoff solenoid to shout off the flow control turbine; and
signaling the shutoff solenoid to shut off the flow to the flow control turbine when the fluid level drops below the shut off fluid level by the use of the control console microcontroller.
